(19) United States
(12) Patent Application Publication
(10) Pub. No.: US 2023/0243942 A1
(43) Pub. Date: Aug. 3, 2023

(54) LIDAR WINDOW BLOCKAGE DETECTION

(71) Applicant: Luminar, LLC, Orlando, FL (US)

(72) Inventors: Stephen L. Mielke, Oviedo, FL (US); Aseem D. Patil, Orlando, FL (US)

(21) Appl. No.: 18/097,002

(22) Filed: Jan. 13, 2023

Related U.S. Application Data
(63) Continuation-in-part of application No. 17/590,459, filed on Feb. 1, 2022.

(51) Int. Cl. G01S 7/497; G01S 7/481; G01S 7/4861; G01S 7/4913

(52) U.S. Cl. CPC G01S 7/497; G01S 7/4817; G01S 7/4861; G01S 7/4913; G01S 2007/4975; G01S 2007/4977

(57) ABSTRACT

A system comprises a light source, a scanner, a first detector, a second detector, and a processor. The light source is configured to emit light and the scanner is configured to scan the emitted light across at least a field of regard through a window. The first detector is configured to detect at least a portion of the emitted light scattered by a target located downrange from the system and the second detector is configured to detect at least a portion of the emitted light scattered by a close object located between the window and a minimum detection distance associated with the first detector. The processor is configured to analyze detected information from the second detector to provide an indication associated with detecting the close object.

### CROSS REFERENCE TO OTHER APPLICATIONS

This application is a continuation in part of U.S. patent application Ser. No. 17/590,459 entitled LIDAR WINDOW BLOCKAGE DETECTION filed Feb. 1, 2022, which is incorporated herein by reference for all purposes.

### BACKGROUND OF THE INVENTION

Light detection and ranging (lidar) is a technology that can be used to measure distances to remote targets. Typically, a lidar system includes a light source and an optical receiver. The light source can include, for example, a laser which emits light having a particular operating wavelength. The operating wavelength of a lidar system may lie, for example, in the infrared, visible, or ultraviolet portions of the electromagnetic spectrum. The light source emits light toward a target which scatters the light, and some of the scattered light is received back at the receiver. The system determines the distance to the target based on one or more characteristics associated with the received light. For example, the lidar system may determine the distance to the target based on the time of flight for a pulse of light emitted by the light source to travel to the target and back to the lidar system.

### BRIEF DESCRIPTION OF THE DRAWINGS

Various embodiments of the invention are disclosed in the following detailed description and the accompanying drawings.

FIG. 1 illustrates an example light detection and ranging (lidar) system.

FIG. 2 illustrates an example scan pattern produced by a lidar system.

FIG. 3 illustrates an example lidar system with an example rotating polygon mirror.

FIG. 4 illustrates an example light-source field of view (FOVL) and receiver field of view (FOVR) for a lidar system.

FIG. 5 illustrates an example unidirectional scan pattern that includes multiple pixels and multiple scan lines.

FIG. 6 illustrates an embodiment of a lidar system capable of detecting blocking contaminants.

FIG. 7 illustrates an embodiment of a readout integrated circuit (ROIC) component of a lidar system capable of detecting blocking contaminants.

FIG. 8 illustrates an example scatter pattern relative to detector site locations of a readout integrated circuit (ROIC) component of a lidar system capable of detecting blocking contaminants.

FIG. 9 illustrates an example scatter pattern relative to detector site locations of a readout integrated circuit (ROIC) component of a lidar system capable of detecting blocking contaminants.

FIG. 10 illustrates an example scatter pattern relative to detector site locations of a readout integrated circuit (ROIC) component of a lidar system capable of detecting blocking contaminants.

FIG. 11 illustrates example scatter patterns relative to detector site locations of a readout integrated circuit (ROIC) component of a lidar system with a single blocking contaminant detector site location.

FIG. 12 illustrates example scatter patterns relative to detector site locations of a readout integrated circuit (ROIC) component of a lidar system with multiple blocking contaminant detector site locations.

FIG. 13 is a flow chart illustrating an embodiment of a process of a lidar system for detecting objects.

FIG. 14 is a flow chart illustrating an embodiment of a process for detecting blocking contaminants on a sensor window.

FIG. 15 illustrates an embodiment of a lidar system capable of detecting blocking close objects.

FIG. 16 illustrates an embodiment of a readout integrated circuit (ROIC) component of a lidar system capable of detecting blocking objects.

FIG. 17 illustrates example scatter patterns relative to detector site locations of a readout integrated circuit (ROIC) component of a lidar system with blocking close object and contaminant detector site locations.

FIG. 18 is a flow chart illustrating an embodiment of a process for detecting blocking close objects in front of a sensor window.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Window blockage detection for light detection and ranging (lidar) systems is disclosed. Using the disclosed systems and techniques, a blocking contaminant on the sensor window of a lidar system can be detected. In various embodiments, a blocking contaminant on the sensor window can interfere with the accuracy of the lidar system. For example, a blocking contaminant can make it difficult for the lidar system to accurately detect and/or determine the distance of downrange targets. Instead of reaching the downrange target, at least a portion of the output beam emitted from the lidar system is instead scattered by the blocking contaminant.

In various embodiments, the blocking contaminants associated with a sensor window can be heavily influenced by the usage scenario of the lidar system. For example, in automotive applications, the contaminant can be a foreign object such as dust, liquids, or other environmental contaminants such as road debris. In some embodiments, the blocking contaminant is due to degradation of the sensor window such as degradation caused by a chip, pitting, and/or UV damage to the sensor window. In various embodiments, the disclosed invention detects a variety of different blocking contaminants associated with the sensor window by detecting the light scattered by the blocking contaminant using one or more additional detectors. For example, an additional detector is placed in the receiver of the lidar system to detect at least a portion of the emitted light that is scattered by the blocking contaminant on the sensor window. The position of a blocking contaminant detector is located such that the blocking contaminant detector accurately detects light scatter from an object on or very near to the sensor window. In various embodiments, the remaining one or more detectors of the receiver are positioned to detect objects downrange. For the disclosed systems, the captured scatter pattern for downrange objects and blocking contaminants is different and each scatter pattern utilizes a different set of detectors. The downrange object detectors are positioned to optimally detect downrange objects and the blocking contaminant detectors are positioned to identify blocking contaminants on the sensor window that could impact the downrange object detectors and the overall accuracy of the lidar system.

In some embodiments, the output of the lidar system is used to trigger a response to address an identified blocking contaminant. For example, in the event a blocking contaminant is detected on the sensor window, a cleaning process, a sensor window replacement process, and/or an additional inspection process can be initiated. For example, a cleaning process can clear debris such as dust or mud from the sensor window. As another example, a replacement process can be utilized to replace or repair a sensor window that is pitted or chipped. In some embodiments, the output of the lidar system is a notification that the sensor window contains a blockage. In some embodiments, the output of the lidar system is a light reading from one or more of the blocking contaminant detectors. For example, the captured sensor data from each blocking contaminant detector can be used to determine intensity readings.

In some embodiments, a lidar system comprises at least a light source, a scanner, a first detector, a second detector, and a processor. The light source is configured to emit light and the scanner is configured to scan the emitted light across a field of regard through a window. For example, a light source such as a laser can emit light of a particular operating wavelength that is scanned by the scanner towards a particular scan region or field of regard. The field of regard may be, for example, the area in front of a vehicle. Other fields of regards are appropriate as well, such as along the sides or behind the vehicle. The emitted light passes through a sensor window before reaching any downrange objects. In some embodiments, the sensor window is used at least in part to protect the lidar system, for example, from environmental elements such as road debris and weather. In various embodiments, the lidar system includes multiple detectors, for example, as part of a receiver module. The detectors can utilize different types of technology to detect scattered light. For example, one or more of the detectors can utilize avalanche photodiodes (APDs), one or more single-photon avalanche diodes (SPADs), one or more PN photodiodes, or one or more PIN photodiodes, etc. The first detector of the lidar system is configured to detect at least a portion of the emitted light scattered by a target located downrange from the system. For example, the positioning of the first detector is optimized to detect objects that are a certain distance from the lidar system and/or the application environment to which the lidar system is mounted, such as an automobile. In some embodiments, the first detector is optimized to detect objects that are up to 50 meters, 200 meters, or another distance away from the lidar system. The second detector of the lidar system is configured to detect at least a portion of the emitted light scattered by a blocking contaminant on the window. For example, contaminants on or embedded in the sensor window are detected by the second detector. In various embodiments, the first and second detectors are different detectors and are configured to detect different scatter patterns. The processor of the lidar system is configured to analyze detected information from the second detector to provide an indication associated with detecting the blocking contaminant on the window. For example, a processor is used to analyze the output of the second detector to determine whether the sensor window has an associated blocking contaminant that can be impacting the first detector.

A lidar system operates in a vehicle and includes multiple “eyes,” each of which has its own field of regard, or an angular range over which the eye scans targets using pulses of light in accordance with a scan pattern. The fields of regard can combine along a certain dimension (e.g., horizontally) to define the overall field of regard of the lidar system. The lidar system then can use data received via both eyes to generate a point cloud or otherwise process the received data.

In a two-eye configuration of the lidar system, the two eyes can be housed together and scan the respective fields of regard via a shared window or separate windows, or the eyes can be housed separately. In the latter case, an assembly referred to as a “sensor head” can include a scanner, a receiver, and an optical element such as a collimator or a laser diode to generate or convey a beam of light.

Depending on the implementation, each eye of a lidar system can include a separate scanner (e.g., each eye can be equipped with a pivotable scan mirror to scan the field of regard vertically and another pivotable scan mirror to scan the field of regard horizontally), a partially shared scanner (e.g., each eye can be equipped with a pivotable scan mirror to scan the field of regard vertically, and a shared polygon mirror can scan the corresponding fields of regard horizontally, using different reflective surfaces), or a fully shared scanner (e.g., a pivotable planar mirror can scan the fields of regard vertically by reflecting incident beams at different regions on the reflective surface, and a shared polygon mirror can scan the corresponding fields of regard horizontally, using different reflective surfaces).

Different hardware configurations allow the lidar system to operate the eyes more independently of each other, as is the case with separate scanners, or less independently, as is the case with a fully shared scanner. For example, the two or more eyes may scan the respective fields of regard using similar or different scan patterns. In one implementation, the two eyes trace out the same pattern, but with a certain time differential to maintain angular separation between light-source fields of view and thereby reduce the probability of cross-talk events between the sensor heads. In another implementation, the two eyes scan the corresponding fields of regard according to different scan patterns, at least in some operational states (e.g., when the vehicle is turning right or left).

Further, according to one approach, two eyes of a lidar system are arranged so that the fields of regard of the eyes are adjacent and non-overlapping. For example, each field of regard can span approximately 60 degrees horizontally and 30 degrees vertically, so that the combined field of regard of the lidar system spans approximately 120 degrees horizontally and 30 degrees vertically. The corresponding scanners (or paths within a shared scanner) can point away from each other at a certain angle, for example, so that the respective fields of regard abut approximately at an axis corresponding to the forward-facing direction of the vehicle.

Alternatively, the lidar system can operate in a “cross-eyed” configuration to create an area of overlap between the fields of regard. The area of overlap can be approximately centered along the forward-facing direction or another direction, which in some implementations a controller can determine dynamically. In this implementation, the two sensor heads can yield a higher density of scan in the area that generally is more important. In some implementations, the fields of regard in a cross-eyed two-eye configuration are offset from each other by a half-pixel value, so that the area of overlap has twice as many pixels. In general, the fields of regard can overlap angularly or translationally. To reduce the probability of cross-talk events (e.g., the situation when a pulse emitted by the light source associated with the first eye is received by the receiver of the second eye), the lidar system can use output beams with different wavelengths.

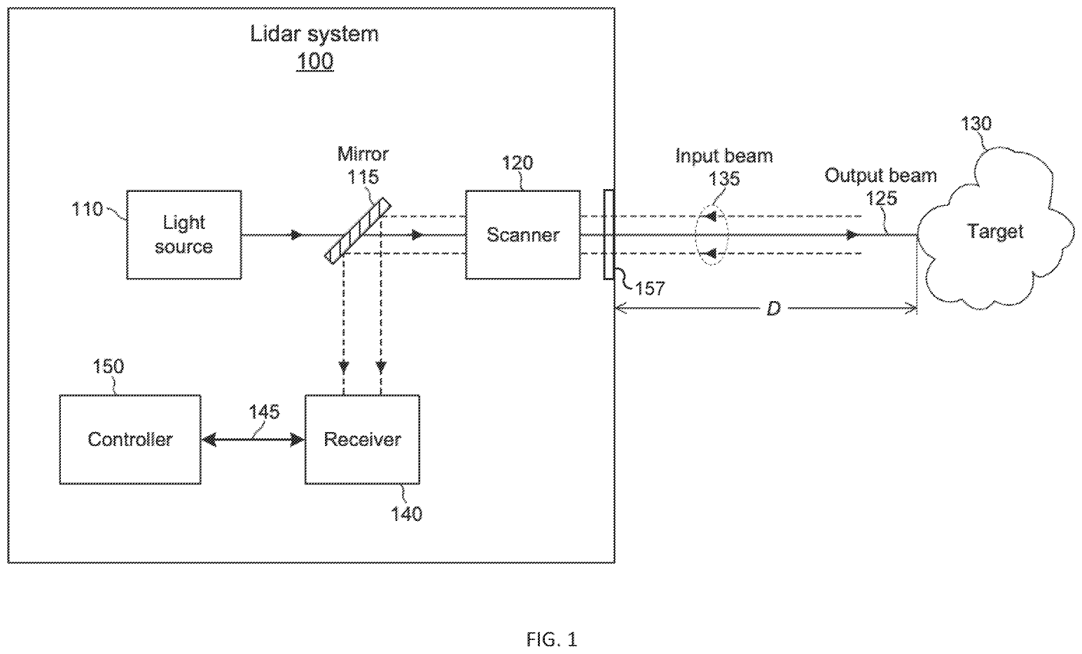

FIG. 1 illustrates an example light detection and ranging (lidar) system 100. In particular embodiments, a lidar system 100 may be referred to as a laser ranging system, a laser radar system, a LIDAR system, a lidar sensor, or a laser detection and ranging (LADAR or ladar) system. In particular embodiments, a lidar system 100 may include a light source 110, mirror 115, scanner 120, receiver 140, controller 150, or sensor window 157. The light source 110 may include, for example, a laser which emits light having a particular operating wavelength in the infrared, visible, or ultraviolet portions of the electromagnetic spectrum. As an example, light source 110 may include a laser with one or more operating wavelengths between approximately 900 nanometers (nm) and 2000 nm. The light source 110 emits an output beam of light 125 which may be continuous wave (CW), pulsed, or modulated in any suitable manner for a given application. The output beam of light 125 is directed downrange toward a remote target 130. As an example, the remote target 130 may be located a distance D of approximately 1 m to 1 km from the lidar system 100.

Once the output beam 125 reaches the downrange target 130, the target may scatter or reflect at least a portion of light from the output beam 125, and some of the scattered or reflected light may return toward the lidar system 100. In the example of FIG. 1, the scattered or reflected light is represented by input beam 135, which passes through sensor window 157 and scanner 120 and is then reflected by mirror 115 and directed to receiver 140. In particular embodiments, a relatively small fraction of the light from output beam 125 may return to the lidar system 100 as input beam 135. As an example, the ratio of input beam 135 average power, peak power, or pulse energy to output beam 125 average power, peak power, or pulse energy may be approximately 10⁻¹, 10⁻², 10⁻³, 10⁻⁴, 10⁻⁵, 10⁻⁶, 10⁻⁷, 10⁻⁸, 10⁻⁹, 10⁻¹⁰, 10⁻¹¹, or 10⁻¹². As another example, if a pulse of output beam 125 has a pulse energy of 1 microjoule (μJ), then the pulse energy of a corresponding pulse of input beam 135 may have a pulse energy of approximately 10 nanojoules (nJ), 1 nJ, 100 picojoules (pJ), 10 pJ, 1 pJ, 100 femtojoules (fJ), 10 fJ, 1 fJ, 100 attojoules (aJ), 10 aJ, 1 aJ, or 0.1 aJ.

In particular embodiments, output beam 125 may include or may be referred to as an optical signal, output optical signal, emitted optical signal, output light, emitted pulse of light, laser beam, light beam, optical beam, emitted beam, emitted light, or beam. In particular embodiments, input beam 135 may include or may be referred to as a received optical signal, received pulse of light, input pulse of light, input optical signal, return beam, received beam, return light, received light, input light, scattered light, or reflected light. As used herein, scattered light may refer to light that is scattered or reflected by a target 130. As an example, an input beam 135 may include: light from the output beam 125 that is scattered by target 130; light from the output beam 125 that is reflected by target 130; or a combination of scattered and reflected light from target 130.

In various embodiments, lidar system 100 includes sensor window 157 through which the beams 125 and 135 pass. In many scenarios, sensor window 157 is free of obstructions and beams 125 and 135 pass through sensor window 157 with minimal degradation. However, under real world conditions, sensor window 157 is exposed to working conditions that can impact the condition of sensor window 157. For example, debris, UV light, weather, road conditions, etc. can create blocking contaminants on sensor window 157 that impact the operation of lidar system 100. In some scenarios, one or more blocking contaminants (not shown) exist on the surface or within sensor window 157. For example, dust, a chip, a pit, liquids, or another occlusion or blockage can damage or degrade a surface of sensor window 157, such as the exterior surface of sensor window 157 from which output beam 125 is intended to pass out from to reach a downrange object such as target 130. The output beam of light 125 is directed downrange towards a remote target 130 but a blocking contaminant of sensor window 157 may scatter or reflect at least a portion of light from the output beam 125 before it reaches remote target 130. Some of the scattered or reflected light from the blockage may return toward the lidar system 100. The light scattered or reflected by the blocking contaminant takes a path similar to input beam 135 and passes through at least a portion of sensor window 157. The light then passes through scanner 120 and is reflected by mirror 115 and directed to receiver 140. In some embodiments, the light scattered or reflected by the blocking contaminant that returns toward the lidar system 100 is an embodiment of input beam 135. For example, although not shown to scale in FIG. 1, in some embodiments, target 130 is not a downrange object but a blocking contaminant on the surface of sensor window 157 and the distance D that target 130 is located from lidar system 100 is effectively zero. In this scenario, target 130 can be a blocking contaminant such as dirt embedded on the surface of sensor window 157 or another blocking contaminant impacting the interior of sensor window 157 such as a chip or pit. Although not shown to scale in FIG. 1, in some embodiments, target 130 is not a downrange object but a close object located between sensor window 157 and a minimum detection distance associated with using a type of detector of lidar system 100 associated with detecting downrange objects. For example, the close object may be a human head, and the minimum detection distance associated with using the type of detector of lidar system 100 associated with detecting downrange objects may be approximately 0.5 meters (e.g., greater than or equal to 0.5 meters). Thus, in some scenarios, a close object within 0.5 meters of sensor window 157 blocks downrange scanning using output beam 125. In particular embodiments, lidar system 100 is configured to lower the output power associated with output beam 125 when the close object is detected. The output power is lowered for various reasons, one being that the output power should be reduced for safety reasons in case the close object is a human head. Stated alternatively, a lower output power is warranted to avoid potential damage to eye and/or other human tissue. Furthermore, if there is a close object that is blocking downrange scanning, a higher output power is unnecessary because the lower output power is sufficient to detect close objects (e.g., within 0.5 meters of sensor window 157).

In particular embodiments, receiver 140 may receive or detect photons from input beam 135 and produce one or more representative signals. For example, the receiver 140 may produce an output electrical signal 145 that is representative of the input beam 135, and the electrical signal 145 may be sent to controller 150. In particular embodiments, receiver 140 or controller 150 may include a processor, computing system (e.g., an ASIC or FPGA), or other suitable circuitry. A controller 150 may be configured to analyze one or more characteristics of the electrical signal 145 from the receiver 140 to determine one or more characteristics of the target 130, such as its distance downrange from the lidar system 100. This may be done, for example, by analyzing a time of flight or a frequency or phase of a transmitted beam of light 125 or a received beam of light 135. If lidar system 100 measures a time of flight of T (e.g., T represents a round-trip time of flight for an emitted pulse of light to travel from the lidar system 100 to the target 130 and back to the lidar system 100), then the distance D from the target 130 to the lidar system 100 may be expressed as D=c·T/2, where c is the speed of light (approximately 3.0×10⁸ m/s). As an example, if a time of flight is measured to be T=300 ns, then the distance from the target 130 to the lidar system 100 may be determined to be approximately D=45.0 m. As another example, if a time of flight is measured to be T=1.33 μs, then the distance from the target 130 to the lidar system 100 may be determined to be approximately D=199.5 m. In particular embodiments, a distance D from lidar system 100 to a target 130 may be referred to as a distance, depth, or range of target 130. As used herein, the speed of light c refers to the speed of light in any suitable medium, such as for example in air, water, or vacuum. As an example, the speed of light in vacuum is approximately 2.9979×10⁸ m/s, and the speed of light in air (which has a refractive index of approximately 1.0003) is approximately 2.9970×10⁸ m/s.

In particular embodiments, light source 110 may include a pulsed or CW laser. As an example, light source 110 may be a pulsed laser configured to produce or emit pulses of light with a pulse duration or pulse width of approximately 10 picoseconds (ps) to 100 nanoseconds (ns). The pulses may have a pulse duration of approximately 100 ps, 200 ps, 400 ps, 1 ns, 2 ns, 5 ns, 10 ns, 20 ns, 50 ns, 100 ns, or any other suitable pulse duration. As another example, light source 110 may be a pulsed laser that produces pulses with a pulse duration of approximately 1-5 ns. As another example, light source 110 may be a pulsed laser that produces pulses at a pulse repetition frequency of approximately 100 kHz to 10 MHz or a pulse period (e.g., a time between consecutive pulses) of approximately 100 ns to 10 μs. In particular embodiments, light source 110 may have a substantially constant pulse repetition frequency, or light source 110 may have a variable or adjustable pulse repetition frequency. As an example, light source 110 may be a pulsed laser that produces pulses at a substantially constant pulse repetition frequency of approximately 640 kHz (e.g., 640,000 pulses per second), corresponding to a pulse period of approximately 1.56 μs. As another example, light source 110 may have a pulse repetition frequency (which may be referred to as a repetition rate) that can be varied from approximately 200 kHz to 3 MHz. As used herein, a pulse of light may be referred to as an optical pulse, a light pulse, or a pulse.

In particular embodiments, light source 110 may include a pulsed or CW laser that produces a free-space output beam 125 having any suitable average optical power. As an example, output beam 125 may have an average power of approximately 1 milliwatt (mW), 10 mW, 100 mW, 1 watt (W), 10 W, or any other suitable average power. In particular embodiments, output beam 125 may include optical pulses with any suitable pulse energy or peak optical power. As an example, output beam 125 may include pulses with a pulse energy of approximately 0.01 μJ, 0.1 μJ, 0.5 μJ, 1 μJ, 2 μJ, 10 μJ, 100 μA 1 mJ, or any other suitable pulse energy. As another example, output beam 125 may include pulses with a peak power of approximately 10 W, 100 W, 1 kW, 5 kW, 10 kW, or any other suitable peak power. The peak power (Pₚₑₐₖ) of a pulse of light can be related to the pulse energy (E) by the expression E=Pₚₑₐₖ·Δt, where Δt is the duration of the pulse, and the duration of a pulse may be defined as the full width at half maximum duration of the pulse. For example, an optical pulse with a duration of 1 ns and a pulse energy of 10 has a peak power of approximately 1 kW. The average power (Pₐᵥ) of an output beam 125 can be related to the pulse repetition frequency (PRF) and pulse energy by the expression Pₐᵥ=PRF·E. For example, if the pulse repetition frequency is 500 kHz, then the average power of an output beam 125 with 1-μJ pulses is approximately 0.5 W.

In particular embodiments, light source 110 may include a laser diode, such as for example, a Fabry-Perot laser diode, a quantum well laser, a distributed Bragg reflector (DBR) laser, a distributed feedback (DFB) laser, a vertical-cavity surface-emitting laser (VCSEL), a quantum dot laser diode, a grating-coupled surface-emitting laser (GCSEL), a slab-coupled optical waveguide laser (SCOWL), a single-transverse-mode laser diode, a multi-mode broad area laser diode, a laser-diode bar, a laser-diode stack, or a tapered-stripe laser diode. As an example, light source 110 may include an aluminum-gallium-arsenide (AlGaAs) laser diode, an indium-gallium-arsenide (InGaAs) laser diode, an indium-gallium-arsenide-phosphide (InGaAsP) laser diode, or a laser diode that includes any suitable combination of aluminum (Al), indium (In), gallium (Ga), arsenic (As), phosphorous (P), or any other suitable material. In particular embodiments, light source 110 may include a pulsed or CW laser diode with a peak emission wavelength between 1200 nm and 1600 nm. As an example, light source 110 may include a current-modulated InGaAsP DFB laser diode that produces optical pulses at a wavelength of approximately 1550 nm. As another example, light source 110 may include a laser diode that emits light at a wavelength between 1500 nm and 1510 nm.

In particular embodiments, light source 110 may include a pulsed or CW laser diode followed by one or more optical-amplification stages. For example, a seed laser diode may produce a seed optical signal, and an optical amplifier may amplify the seed optical signal to produce an amplified optical signal that is emitted by the light source 110. In particular embodiments, an optical amplifier may include a fiber-optic amplifier or a semiconductor optical amplifier (SOA). For example, a pulsed laser diode may produce relatively low-power optical seed pulses which are amplified by a fiber-optic amplifier. As another example, a light source 110 may include a fiber-laser module that includes a current-modulated laser diode with an operating wavelength of approximately 1550 nm followed by a single-stage or a multi-stage erbium-doped fiber amplifier (EDFA) or erbium-ytterbium-doped fiber amplifier (EYDFA) that amplifies the seed pulses from the laser diode. As another example, light source 110 may include a continuous-wave (CW) or quasi-CW laser diode followed by an external optical modulator (e.g., an electro-optic amplitude modulator). The optical modulator may modulate the CW light from the laser diode to produce optical pulses which are sent to a fiber-optic amplifier or SOA. As another example, light source 110 may include a pulsed or CW seed laser diode followed by a semiconductor optical amplifier (SOA). The SOA may include an active optical waveguide configured to receive light from the seed laser diode and amplify the light as it propagates through the waveguide. The optical gain of the SOA may be provided by pulsed or direct-current (DC) electrical current supplied to the SOA. The SOA may be integrated on the same chip as the seed laser diode, or the SOA may be a separate device with an anti-reflection coating on its input facet or output facet. As another example, light source 110 may include a seed laser diode followed by an SOA, which in turn is followed by a fiber-optic amplifier. For example, the seed laser diode may produce relatively low-power seed pulses which are amplified by the SOA, and the fiber-optic amplifier may further amplify the optical pulses.

In particular embodiments, light source 110 may include a direct-emitter laser diode. A direct-emitter laser diode (which may be referred to as a direct emitter) may include a laser diode which produces light that is not subsequently amplified by an optical amplifier. A light source 110 that includes a direct-emitter laser diode may not include an optical amplifier, and the output light produced by a direct emitter may not be amplified after it is emitted by the laser diode. The light produced by a direct-emitter laser diode (e.g., optical pulses, CW light, or frequency-modulated light) may be emitted directly as a free-space output beam 125 without being amplified. A direct-emitter laser diode may be driven by an electrical power source that supplies current pulses to the laser diode, and each current pulse may result in the emission of an output optical pulse.

In particular embodiments, light source 110 may include a diode-pumped solid-state (DPSS) laser. A DPSS laser (which may be referred to as a solid-state laser) may refer to a laser that includes a solid-state, glass, ceramic, or crystal-based gain medium that is pumped by one or more pump laser diodes. The gain medium may include a host material that is doped with rare-earth ions (e.g., neodymium, erbium, ytterbium, or praseodymium). For example, a gain medium may include a yttrium aluminum garnet (YAG) crystal that is doped with neodymium (Nd) ions, and the gain medium may be referred to as a Nd:YAG crystal. A DPSS laser with a Nd:YAG gain medium may produce light at a wavelength between approximately 1300 nm and approximately 1400 nm, and the Nd:YAG gain medium may be pumped by one or more pump laser diodes with an operating wavelength between approximately 730 nm and approximately 900 nm. A DPSS laser may be a passively Q-switched laser that includes a saturable absorber (e.g., a vanadium-doped crystal that acts as a saturable absorber). Alternatively, a DPSS laser may be an actively Q-switched laser that includes an active Q-switch (e.g., an acousto-optic modulator or an electro-optic modulator). A passively or actively Q-switched DPSS laser may produce output optical pulses that form an output beam 125 of a lidar system 100.

In particular embodiments, an output beam of light 125 emitted by light source 110 may be a collimated optical beam having any suitable beam divergence, such as for example, a full-angle beam divergence of approximately 0.5 to 10 milliradians (mrad). A divergence of output beam 125 may refer to an angular measure of an increase in beam size (e.g., a beam radius or beam diameter) as output beam 125 travels away from light source 110 or lidar system 100. In particular embodiments, output beam 125 may have a substantially circular cross section with a beam divergence characterized by a single divergence value. As an example, an output beam 125 with a circular cross section and a full-angle beam divergence of 2 mrad may have a beam diameter or spot size of approximately 20 cm at a distance of 100 m from lidar system 100. In particular embodiments, output beam 125 may have a substantially elliptical cross section characterized by two divergence values. As an example, output beam 125 may have a fast axis and a slow axis, where the fast-axis divergence is greater than the slow-axis divergence. As another example, output beam 125 may be an elliptical beam with a fast-axis divergence of 4 mrad and a slow-axis divergence of 2 mrad.

In particular embodiments, an output beam of light 125 emitted by light source 110 may be unpolarized or randomly polarized, may have no specific or fixed polarization (e.g., the polarization may vary with time), or may have a particular polarization (e.g., output beam 125 may be linearly polarized, elliptically polarized, or circularly polarized). As an example, light source 110 may produce light with no specific polarization or may produce light that is linearly polarized.

In particular embodiments, lidar system 100 may include one or more optical components configured to reflect, focus, filter, shape, modify, steer, or direct light within the lidar system 100 or light produced or received by the lidar system 100 (e.g., output beam 125 or input beam 135). As an example, lidar system 100 may include one or more lenses, mirrors, filters (e.g., band-pass or interference filters), beam splitters, optical splitters, polarizers, polarizing beam splitters, wave plates (e.g., half-wave or quarter-wave plates), diffractive elements, holographic elements, isolators, couplers, detectors, beam combiners, or collimators. The optical components in a lidar system 100 may be free-space optical components, fiber-coupled optical components, or a combination of free-space and fiber-coupled optical components.

In particular embodiments, lidar system 100 may include a telescope, one or more lenses, or one or more mirrors configured to expand, focus, or collimate the output beam 125 or the input beam 135 to a desired beam diameter or divergence. As an example, the lidar system 100 may include one or more lenses to focus the input beam 135 onto a photodetector of receiver 140. As another example, the lidar system 100 may include one or more flat mirrors or curved mirrors (e.g., concave, convex, or parabolic mirrors) to steer or focus the output beam 125 or the input beam 135. For example, the lidar system 100 may include an off-axis parabolic mirror to focus the input beam 135 onto a photodetector of receiver 140. As illustrated in FIG. 1, the lidar system 100 may include mirror 115 (which may be a metallic or dielectric mirror), and mirror 115 may be configured so that light beam 125 passes through the mirror 115 or passes along an edge or side of the mirror 115 and input beam 135 is reflected toward the receiver 140. As an example, mirror 115 (which may be referred to as an overlap mirror, superposition mirror, or beam-combiner mirror) may include a hole, slot, or aperture which output light beam 125 passes through. As another example, rather than passing through the mirror 115, the output beam 125 may be directed to pass alongside the mirror 115 with a gap (e.g., a gap of width approximately 0.1 mm, 0.5 mm, 1 mm, 2 mm, 5 mm, or 10 mm) between the output beam 125 and an edge of the mirror 115.

In particular embodiments, mirror 115 may provide for output beam 125 and input beam 135 to be substantially coaxial so that the two beams travel along approximately the same optical path (albeit in opposite directions). The input and output beams being substantially coaxial may refer to the beams being at least partially overlapped or sharing a common propagation axis so that input beam 135 and output beam 125 travel along substantially the same optical path (albeit in opposite directions). As an example, output beam 125 and input beam 135 may be parallel to each other to within less than 10 mrad, 5 mrad, 2 mrad, 1 mrad, 0.5 mrad, or 0.1 mrad. As output beam 125 is scanned across a field of regard, the input beam 135 may follow along with the output beam 125 so that the coaxial relationship between the two beams is maintained.

In particular embodiments, lidar system 100 may include a scanner 120 configured to scan an output beam 125 across a field of regard of the lidar system 100. As an example, scanner 120 may include one or more scanning mirrors configured to pivot, rotate, oscillate, or move in an angular manner about one or more rotation axes. The output beam 125 may be reflected by a scanning mirror, and as the scanning mirror pivots or rotates, the reflected output beam 125 may be scanned in a corresponding angular manner. As an example, a scanning mirror may be configured to periodically pivot back and forth over a 30-degree range, which results in the output beam 125 scanning back and forth across a 60-degree range (e.g., a 0-degree rotation by a scanning mirror results in a 20-degree angular scan of output beam 125).

In particular embodiments, a scanning mirror (which may be referred to as a scan mirror) may be attached to or mechanically driven by a scanner actuator or mechanism which pivots or rotates the mirror over a particular angular range (e.g., over a 5° angular range, 30° angular range, 60° angular range, 120° angular range, 360° angular range, or any other suitable angular range). A scanner actuator or mechanism configured to pivot or rotate a mirror may include a galvanometer scanner, a resonant scanner, a piezoelectric actuator, a voice coil motor, an electric motor (e.g., a DC motor, a brushless DC motor, a synchronous electric motor, or a stepper motor), a microelectromechanical systems (MEMS) device, or any other suitable actuator or mechanism. As an example, a scanner 120 may include a scanning mirror attached to a galvanometer scanner configured to pivot back and forth over a 1° to 30° angular range. As another example, a scanner 120 may include a scanning mirror that is attached to or is part of a MEMS device configured to scan over a 1° to 30° angular range. As another example, a scanner 120 may include a polygon mirror configured to rotate continuously in the same direction (e.g., rather than pivoting back and forth, the polygon mirror continuously rotates 360 degrees in a clockwise or counterclockwise direction). The polygon mirror may be coupled or attached to a synchronous motor configured to rotate the polygon mirror at a substantially fixed rotational frequency (e.g., a rotational frequency of approximately 1 Hz, 10 Hz, 50 Hz, 100 Hz, 500 Hz, or 1,000 Hz).

In particular embodiments, scanner 120 may be configured to scan the output beam 125 (which may include at least a portion of the light emitted by light source 110) across a field of regard of the lidar system 100. A field of regard (FOR) of a lidar system 100 may refer to an area, region, or angular range over which the lidar system 100 may be configured to scan or capture distance information. As an example, a lidar system 100 with an output beam 125 with a 30-degree scanning range may be referred to as having a 30-degree angular field of regard. As another example, a lidar system 100 with a scanning mirror that rotates over a 30-degree range may produce an output beam 125 that scans across a 60-degree range (e.g., a 60-degree FOR). In particular embodiments, lidar system 100 may have a FOR of approximately 10°, 20°, 40°, 60°, 120°, 360°, or any other suitable FOR.

In particular embodiments, scanner 120 may be configured to scan the output beam 125 horizontally and vertically, and lidar system 100 may have a particular FOR along the horizontal direction and another particular FOR along the vertical direction. As an example, lidar system 100 may have a horizontal FOR of 10° to 120° and a vertical FOR of 2° to 45°. In particular embodiments, scanner 120 may include a first scan mirror and a second scan mirror, where the first scan mirror directs the output beam 125 toward the second scan mirror, and the second scan mirror directs the output beam 125 downrange from the lidar system 100. As an example, the first scan mirror may scan the output beam 125 along a first direction, and the second scan mirror may scan the output beam 125 along a second direction that is substantially orthogonal to the first direction. As another example, the first scan mirror may scan the output beam 125 along a substantially horizontal direction, and the second scan mirror may scan the output beam 125 along a substantially vertical direction (or vice versa). As another example, the first and second scan mirrors may each be driven by galvanometer scanners. As another example, the first or second scan mirror may include a polygon mirror driven by an electric motor. In particular embodiments, scanner 120 may be referred to as a beam scanner, optical scanner, or laser scanner.

In particular embodiments, one or more scanning mirrors may be communicatively coupled to controller 150 which may control the scanning mirror(s) so as to guide the output beam 125 in a desired direction downrange or along a desired scan pattern. In particular embodiments, a scan pattern may refer to a pattern or path along which the output beam 125 is directed. As an example, scanner 120 may include two scanning mirrors configured to scan the output beam 125 across a 60° horizontal FOR and a 20° vertical FOR. The two scanner mirrors may be controlled to follow a scan path that substantially covers the 60°×20° FOR. As an example, the scan path may result in a point cloud with pixels that substantially cover the 60°×20° FOR. The pixels may be approximately evenly distributed across the 60°×20° FOR. Alternatively, the pixels may have a particular nonuniform distribution (e.g., the pixels may be distributed across all or a portion of the 60°×20° FOR, and the pixels may have a higher density in one or more particular regions of the 60°×20° FOR).

In particular embodiments, a lidar system 100 may include a scanner 120 with a solid-state scanning device. A solid-state scanning device may refer to a scanner 120 that scans an output beam 125 without the use of moving parts (e.g., without the use of a mechanical scanner, such as a mirror that rotates or pivots). For example, a solid-state scanner 120 may include one or more of the following: an optical phased array scanning device; a liquid-crystal scanning device; or a liquid lens scanning device. A solid-state scanner 120 may be an electrically addressable device that scans an output beam 125 along one axis (e.g., horizontally) or along two axes (e.g., horizontally and vertically). In particular embodiments, a scanner 120 may include a solid-state scanner and a mechanical scanner. For example, a scanner 120 may include an optical phased array scanner configured to scan an output beam 125 in one direction and a galvanometer scanner that scans the output beam 125 in an orthogonal direction. The optical phased array scanner may scan the output beam relatively rapidly in a horizontal direction across the field of regard (e.g., at a scan rate of 50 to 1,000 scan lines per second), and the galvanometer may pivot a mirror at a rate of 1-30 Hz to scan the output beam 125 vertically.

In particular embodiments, a lidar system 100 may include a light source 110 configured to emit pulses of light and a scanner 120 configured to scan at least a portion of the emitted pulses of light across a field of regard of the lidar system 100. One or more of the emitted pulses of light may be scattered by a target 130 located downrange from the lidar system 100, and a receiver 140 may detect at least a portion of the pulses of light scattered by the target 130. A receiver 140 may be referred to as a photoreceiver, optical receiver, optical sensor, detector, photodetector, or optical detector. In particular embodiments, lidar system 100 may include a receiver 140 that receives or detects at least a portion of input beam 135 and produces an electrical signal that corresponds to input beam 135. As an example, if input beam 135 includes an optical pulse, then receiver 140 may produce an electrical current or voltage pulse that corresponds to the optical pulse detected by receiver 140. As another example, receiver 140 may include one or more avalanche photodiodes (APDs) or one or more single-photon avalanche diodes (SPADs). As another example, receiver 140 may include one or more PN photodiodes (e.g., a photodiode structure formed by a p-type semiconductor and an n-type semiconductor, where the PN acronym refers to the structure having p-doped and n-doped regions) or one or more PIN photodiodes (e.g., a photodiode structure formed by an undoped intrinsic semiconductor region located between p-type and n-type regions, where the PIN acronym refers to the structure having p-doped, intrinsic, and n-doped regions). An APD, SPAD, PN photodiode, or PIN photodiode may each be referred to as a detector, photodetector, or photodiode. A detector may have an active region or an avalanche-multiplication region that includes silicon, germanium, InGaAs, InAsSb (indium arsenide antimonide), AlAsSb (aluminum arsenide antimonide), or AlInAsSb (aluminum indium arsenide antimonide). The active region may refer to an area over which a detector may receive or detect input light. An active region may have any suitable size or diameter, such as for example, a diameter of approximately 10 μm, 25 μm, 50 μm, 80 μm, 100 μm, 200 μm, 500 μm, 1 mm, 2 mm, or 5 mm.

In particular embodiments, receiver 140 may include electronic circuitry that performs signal amplification, sampling, filtering, signal conditioning, analog-to-digital conversion, time-to-digital conversion, pulse detection, threshold detection, rising-edge detection, or falling-edge detection. As an example, receiver 140 may include a transimpedance amplifier that converts a received photocurrent (e.g., a current produced by an APD in response to a received optical signal) into a voltage signal. The voltage signal may be sent to pulse-detection circuitry that produces an analog or digital output signal 145 that corresponds to one or more optical characteristics (e.g., rising edge, falling edge, amplitude, duration, or energy) of a received optical pulse. As an example, the pulse-detection circuitry may perform a time-to-digital conversion to produce a digital output signal 145. The electrical output signal 145 may be sent to controller 150 for processing or analysis (e.g., to determine a time-of-flight value corresponding to a received optical pulse).

In particular embodiments, a controller 150 (which may include or may be referred to as a processor, an FPGA, an ASIC, a computer, or a computing system) may be located within a lidar system 100 or outside of a lidar system 100. Alternatively, one or more parts of a controller 150 may be located within a lidar system 100, and one or more other parts of a controller 150 may be located outside a lidar system 100. In particular embodiments, one or more parts of a controller 150 may be located within a receiver 140 of a lidar system 100, and one or more other parts of a controller 150 may be located in other parts of the lidar system 100. For example, a receiver 140 may include an FPGA or ASIC configured to process an output electrical signal from the receiver 140, and the processed signal may be sent to a computing system located elsewhere within the lidar system 100 or outside the lidar system 100. In particular embodiments, a controller 150 may include any suitable arrangement or combination of logic circuitry, analog circuitry, or digital circuitry.

In particular embodiments, controller 150 may be electrically coupled or communicatively coupled to light source 110, scanner 120, or receiver 140. As an example, controller 150 may receive electrical trigger pulses or edges from light source 110, where each pulse or edge corresponds to the emission of an optical pulse by light source 110. As another example, controller 150 may provide instructions, a control signal, or a trigger signal to light source 110 indicating when light source 110 should produce optical pulses. Controller 150 may send an electrical trigger signal that includes electrical pulses, where each electrical pulse results in the emission of an optical pulse by light source 110. In particular embodiments, the frequency, period, duration, pulse energy, peak power, average power, or wavelength of the optical pulses produced by light source 110 may be adjusted based on instructions, a control signal, or trigger pulses provided by controller 150. In particular embodiments, controller 150 may be coupled to light source 110 and receiver 140, and controller 150 may determine a time-of-flight value for an optical pulse based on timing information associated with when the pulse was emitted by light source 110 and when a portion of the pulse (e.g., input beam 135) was detected or received by receiver 140. In particular embodiments, controller 150 may include circuitry that performs signal amplification, sampling, filtering, signal conditioning, analog-to-digital conversion, time-to-digital conversion, pulse detection, threshold detection, rising-edge detection, or falling-edge detection.

In particular embodiments, lidar system 100 may include one or more processors (e.g., a controller 150) configured to determine a distance D from the lidar system 100 to a target 130 based at least in part on a round-trip time of flight for an emitted pulse of light to travel from the lidar system 100 to the target 130 and back to the lidar system 100. The target 130 may be at least partially contained within a field of regard of the lidar system 100 and located a distance D from the lidar system 100 that is less than or equal to an operating range (R_{OP}) of the lidar system 100. In particular embodiments, an operating range (which may be referred to as an operating distance) of a lidar system 100 may refer to a distance over which the lidar system 100 is configured to sense or identify targets 130 located within a field of regard of the lidar system 100. The operating range of lidar system 100 may be any suitable distance, such as for example, 25 m, 50 m, 100 m, 200 m, 250 m, 500 m, or 1 km. As an example, a lidar system 100 with a 200-m operating range may be configured to sense or identify various targets 130 located up to 200 m away from the lidar system 100. The operating range R_{OP} of a lidar system 100 may be related to the time τ between the emission of successive optical signals by the expression R_{OP}=c·τ/2. For a lidar system 100 with a 200-m operating range (R_{OP}=200 m), the time τ between successive pulses (which may be referred to as a pulse period, a pulse repetition interval (PRI), or a time period between pulses) is approximately 2 R_{OP}/c≅1.33 μs. The pulse period τ may also correspond to the time of flight for a pulse to travel to and from a target 130 located a distance R_{OP} from the lidar system 100. Additionally, the pulse period τ may be related to the pulse repetition frequency (PRF) by the expression τ=1/PRF. For example, a pulse period of 1.33 μs corresponds to a PRF of approximately 752 kHz.

In particular embodiments, a lidar system 100 may be used to determine the distance to one or more downrange targets 130. By scanning the lidar system 100 across a field of regard, the system may be used to map the distance to a number of points within the field of regard. Each of these depth-mapped points may be referred to as a pixel or a voxel. A collection of pixels captured in succession (which may be referred to as a depth map, a point cloud, or a frame) may be rendered as an image or may be analyzed to identify or detect objects or to determine a shape or distance of objects within the FOR. As an example, a point cloud may cover a field of regard that extends 60° horizontally and 15° vertically, and the point cloud may include a frame of 100-2000 pixels in the horizontal direction by 4-400 pixels in the vertical direction.

In particular embodiments, a lidar system 100 may be used to determine the existence of one or more blocking contaminants on sensor window 157 of lidar system 100. Blocking contaminants can impact the ability of lidar system 100 to determine the existence and/or distance to one or more downrange targets 130. Depending on the severity of the influence of the blocking contaminants, the resulting point cloud from mapping downrange objects within the field of regard is impacted and the accuracy of the depth-mapped points can significantly decrease. By identifying the existence of blocking contaminants, lidar system 100 can be modified to compensate for the contaminants. For example, lidar system 100 can trigger a cleaning process to clear any blocking contaminants from sensor window 157 of lidar system 100. As another example, in the scenario where sensor window 157 is permanently damaged, lidar system 100 can trigger a maintenance process such as a process to replace sensor window 157, to disable regions within the field of regard from mapping, and/or to rely on a secondary lidar system for mapping certain regions. These approaches can be an effective solution in the event sensor window 157 is severely damaged.

In particular embodiments, lidar system 100 may be configured to repeatedly capture or generate point clouds of a field of regard at any suitable frame rate between approximately 0.1 frames per second (FPS) and approximately 1,000 FPS. As an example, lidar system 100 may generate point clouds at a frame rate of approximately 0.1 FPS, 0.5 FPS, 1 FPS, 2 FPS, 5 FPS, 10 FPS, 20 FPS, 100 FPS, 500 FPS, or 1,000 FPS. As another example, lidar system 100 may be configured to produce optical pulses at a rate of 5×10⁵ pulses/second (e.g., the system may determine 500,000 pixel distances per second) and scan a frame of 1000×50 pixels (e.g., 50,000 pixels/frame), which corresponds to a point-cloud frame rate of 10 frames per second (e.g., 10 point clouds per second). In particular embodiments, a point-cloud frame rate may be substantially fixed, or a point-cloud frame rate may be dynamically adjustable. As an example, a lidar system 100 may capture one or more point clouds at a particular frame rate (e.g., 1 Hz) and then switch to capture one or more point clouds at a different frame rate (e.g., 10 Hz). A slower frame rate (e.g., 1 Hz) may be used to capture one or more high-resolution point clouds, and a faster frame rate (e.g., 10 Hz) may be used to rapidly capture multiple lower-resolution point clouds.

In particular embodiments, a lidar system 100 may be configured to sense, identify, or determine distances to one or more targets 130 within a field of regard. As an example, a lidar system 100 may determine a distance to a target 130, where all or part of the target 130 is contained within a field of regard of the lidar system 100. All or part of a target 130 being contained within a FOR of the lidar system 100 may refer to the FOR overlapping, encompassing, or enclosing at least a portion of the target 130. In particular embodiments, target 130 may include all or part of an object that is moving or stationary relative to lidar system 100. As an example, target 130 may include all or a portion of a person, vehicle, motorcycle, truck, train, bicycle, wheelchair, pedestrian, animal, road sign, traffic light, lane marking, road-surface marking, parking space, pylon, guard rail, traffic barrier, pothole, railroad crossing, obstacle in or near a road, curb, stopped vehicle on or beside a road, utility pole, house, building, trash can, mailbox, tree, any other suitable object, or any suitable combination of all or part of two or more objects. In particular embodiments, a target may be referred to as an object.

In particular embodiments, light source 110, scanner 120, and receiver 140 may be packaged together within a single housing, where a housing may refer to a box, case, or enclosure that includes sensor window 157 and holds or contains all or part of a lidar system 100. As an example, a lidar-system enclosure may contain a light source 110, mirror 115, scanner 120, and receiver 140 of a lidar system 100. Additionally, the lidar-system enclosure may include a controller 150. The lidar-system enclosure may also include one or more electrical connections for conveying electrical power or electrical signals to or from the enclosure. In particular embodiments, one or more components of a lidar system 100 may be located remotely from a lidar-system enclosure. As an example, all or part of light source 110 may be located remotely from a lidar-system enclosure, and pulses of light produced by the light source 110 may be conveyed to the enclosure via optical fiber. As another example, all or part of a controller 150 may be located remotely from a lidar-system enclosure.

In particular embodiments, light source 110 may include an eye-safe laser, or lidar system 100 may be classified as an eye-safe laser system or laser product. An eye-safe laser, laser system, or laser product may refer to a system that includes a laser with an emission wavelength, average power, peak power, peak intensity, pulse energy, beam size, beam divergence, exposure time, or scanned output beam such that emitted light from the system presents little or no possibility of causing damage to a person's eyes. As an example, light source 110 or lidar system 100 may be classified as a Class 1 laser product (as specified by the 60825-1:2014 standard of the International Electrotechnical Commission (IEC)) or a Class I laser product (as specified by Title 21, Section 1040.10 of the United States Code of Federal Regulations (CFR)) that is safe under all conditions of normal use. In particular embodiments, lidar system 100 may be an eye-safe laser product (e.g., with a Class 1 or Class I classification) configured to operate at any suitable wavelength between approximately 900 nm and approximately 2100 nm. As an example, lidar system 100 may include a laser with an operating wavelength between approximately 1200 nm and approximately 1400 nm or between approximately 1400 nm and approximately 1600 nm, and the laser or the lidar system 100 may be operated in an eye-safe manner. As another example, lidar system 100 may be an eye-safe laser product that includes a scanned laser with an operating wavelength between approximately 900 nm and approximately 1700 nm. As another example, lidar system 100 may be a Class 1 or Class I laser product that includes a laser diode, fiber laser, or solid-state laser with an operating wavelength between approximately 1200 nm and approximately 1600 nm. As another example, lidar system 100 may have an operating wavelength between approximately 1500 nm and approximately 1510 nm.

In particular embodiments, one or more lidar systems 100 may be integrated into a vehicle. As an example, multiple lidar systems 100 may be integrated into a car to provide a complete 360-degree horizontal FOR around the car. As another example, 2-10 lidar systems 100, each system having a 45-degree to 180-degree horizontal FOR, may be combined together to form a sensing system that provides a point cloud covering a 360-degree horizontal FOR. The lidar systems 100 may be oriented so that adjacent FORs have an amount of spatial or angular overlap to allow data from the multiple lidar systems 100 to be combined or stitched together to form a single or continuous 360-degree point cloud. As an example, the FOR of each lidar system 100 may have approximately 1-30 degrees of overlap with an adjacent FOR. In particular embodiments, a vehicle may refer to a mobile machine configured to transport people or cargo. For example, a vehicle may include, may take the form of, or may be referred to as a car, automobile, motor vehicle, truck, bus, van, trailer, off-road vehicle, farm vehicle, lawn mower, construction equipment, forklift, robot, golf cart, motorhome, taxi, motorcycle, scooter, bicycle, skateboard, train, snowmobile, watercraft (e.g., a ship or boat), aircraft (e.g., a fixed-wing aircraft, helicopter, or dirigible), unmanned aerial vehicle (e.g., drone), or spacecraft. In particular embodiments, a vehicle may include an internal combustion engine or an electric motor that provides propulsion for the vehicle.

In particular embodiments, one or more lidar systems 100 may be included in a vehicle as part of an advanced driver assistance system (ADAS) to assist a driver of the vehicle in operating the vehicle. For example, a lidar system 100 may be part of an ADAS that provides information (e.g., about the surrounding environment) or feedback to a driver (e.g., to alert the driver to potential problems or hazards) or that automatically takes control of part of a vehicle (e.g., a braking system or a steering system) to avoid collisions or accidents. A lidar system 100 may be part of a vehicle ADAS that provides adaptive cruise control, automated braking, automated parking, collision avoidance, alerts the driver to hazards or other vehicles, maintains the vehicle in the correct lane, or provides a warning if an object or another vehicle is in a blind spot.

In particular embodiments, one or more lidar systems 100 may be integrated into a vehicle as part of an autonomous-vehicle driving system. As an example, a lidar system 100 may provide information about the surrounding environment to a driving system of an autonomous vehicle. An autonomous-vehicle driving system may be configured to guide the autonomous vehicle through an environment surrounding the vehicle and toward a destination. An autonomous-vehicle driving system may include one or more computing systems that receive information from a lidar system 100 about the surrounding environment, analyze the received information, and provide control signals to the vehicle's driving systems (e.g., steering mechanism, accelerator, brakes, lights, or turn signals). As an example, a lidar system 100 integrated into an autonomous vehicle may provide an autonomous-vehicle driving system with a point cloud every 0.1 seconds (e.g., the point cloud has a 10 Hz update rate, representing 10 frames per second). The autonomous-vehicle driving system may analyze the received point clouds to sense or identify targets 130 and their respective locations, distances, or speeds, and the autonomous-vehicle driving system may update control signals based on this information. As an example, if lidar system 100 detects a vehicle ahead that is slowing down or stopping, the autonomous-vehicle driving system may send instructions to release the accelerator and apply the brakes.

In particular embodiments, an autonomous vehicle may be referred to as an autonomous car, driverless car, self-driving car, robotic car, or unmanned vehicle. In particular embodiments, an autonomous vehicle may refer to a vehicle configured to sense its environment and navigate or drive with little or no human input. As an example, an autonomous vehicle may be configured to drive to any suitable location and control or perform all safety-critical functions (e.g., driving, steering, braking, parking) for the entire trip, with the driver not expected to control the vehicle at any time. As another example, an autonomous vehicle may allow a driver to safely turn their attention away from driving tasks in particular environments (e.g., on freeways), or an autonomous vehicle may provide control of a vehicle in all but a few environments, requiring little or no input or attention from the driver.

In particular embodiments, an autonomous vehicle may be configured to drive with a driver present in the vehicle, or an autonomous vehicle may be configured to operate the vehicle with no driver present. As an example, an autonomous vehicle may include a driver's seat with associated controls (e.g., steering wheel, accelerator pedal, and brake pedal), and the vehicle may be configured to drive with no one seated in the driver's seat or with little or no input from a person seated in the driver's seat. As another example, an autonomous vehicle may not include any driver's seat or associated driver's controls, and the vehicle may perform substantially all driving functions (e.g., driving, steering, braking, parking, and navigating) without human input. As another example, an autonomous vehicle may be configured to operate without a driver (e.g., the vehicle may be configured to transport human passengers or cargo without a driver present in the vehicle). As another example, an autonomous vehicle may be configured to operate without any human passengers (e.g., the vehicle may be configured for transportation of cargo without having any human passengers onboard the vehicle).

In particular embodiments, an optical signal (which may be referred to as a light signal, a light waveform, an optical waveform, an output beam, an emitted optical signal, or emitted light) may include pulses of light, CW light, amplitude-modulated light, frequency-modulated (FM) light, or any suitable combination thereof. Although this disclosure describes or illustrates example embodiments of lidar systems 100 or light sources 110 that produce optical signals that include pulses of light, the embodiments described or illustrated herein may also be applied, where appropriate, to other types of optical signals, including continuous-wave (CW) light, amplitude-modulated optical signals, or frequency-modulated optical signals. For example, a lidar system 100 as described or illustrated herein may be a pulsed lidar system and may include a light source 110 that produces pulses of light. Alternatively, a lidar system 100 may be configured to operate as a frequency-modulated continuous-wave (FMCW) lidar system and may include a light source 110 that produces CW light or a frequency-modulated optical signal.

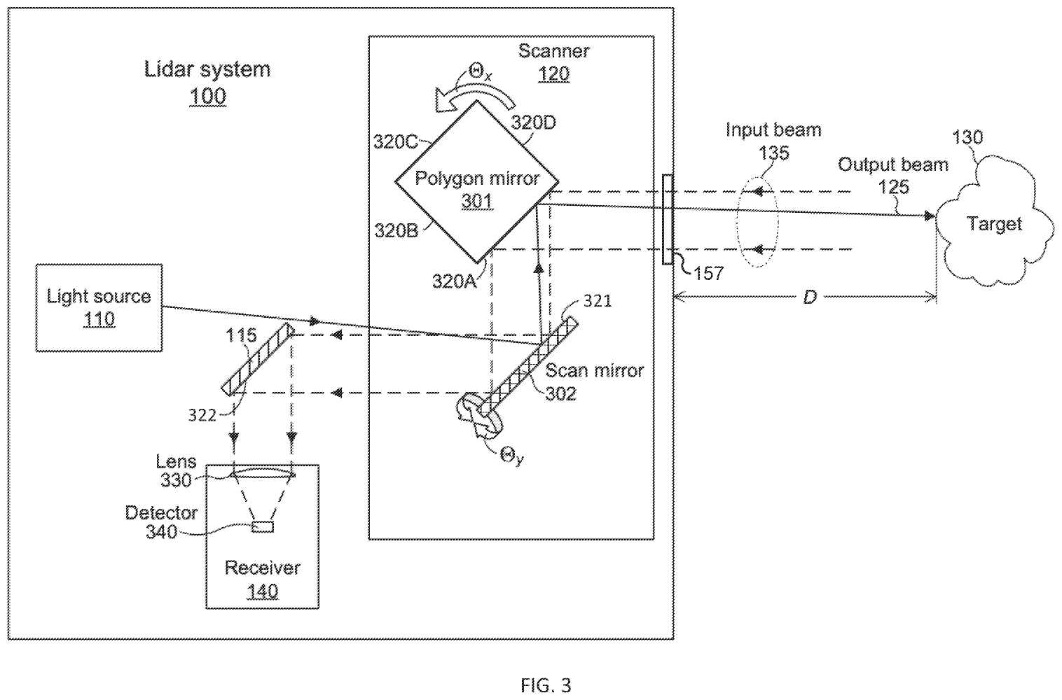

In particular embodiments, a lidar system 100 may be an FMCW lidar system where the emitted light from the light source 110 (e.g., output beam 125 in FIG. 1 or FIG. 3) includes frequency-modulated light. A pulsed lidar system is a type of lidar system 100 in which the light source 110 emits pulses of light, and the distance to a remote target 130 is determined based on the round-trip time-of-flight for a pulse of light to travel to the target 130 and back. Another type of lidar system 100 is a frequency-modulated lidar system, which may be referred to as a frequency-modulated continuous-wave (FMCW) lidar system. An FMCW lidar system uses frequency-modulated light to determine the distance to a remote target 130 based on a frequency of received light (which includes emitted light scattered by the remote target) relative to a frequency of local-oscillator (LO) light. A round-trip time for the emitted light to travel to a target 130 and back to the lidar system may correspond to a frequency difference between the received scattered light and the LO light. A larger frequency difference may correspond to a longer round-trip time and a greater distance to the target 130.

A light source 110 for a FMCW lidar system may include (i) a direct-emitter laser diode, (ii) a seed laser diode followed by an SOA, (iii) a seed laser diode followed by a fiber-optic amplifier, or (iv) a seed laser diode followed by an SOA and then a fiber-optic amplifier. A seed laser diode or a direct-emitter laser diode may be operated in a CW manner (e.g., by driving the laser diode with a substantially constant DC current), and a frequency modulation may be provided by an external modulator (e.g., an electro-optic phase modulator may apply a frequency modulation to seed-laser light). Alternatively, a frequency modulation may be produced by applying a current modulation to a seed laser diode or a direct-emitter laser diode. The current modulation (which may be provided along with a DC bias current) may produce a corresponding refractive-index modulation in the laser diode, which results in a frequency modulation of the light emitted by the laser diode. The current-modulation component (and the corresponding frequency modulation) may have any suitable frequency or shape (e.g., piecewise linear, sinusoidal, triangle-wave, or sawtooth). For example, the current-modulation component (and the resulting frequency modulation of the emitted light) may increase or decrease monotonically over a particular time interval. As another example, the current-modulation component may include a triangle or sawtooth wave with an electrical current that increases or decreases linearly over a particular time interval, and the light emitted by the laser diode may include a corresponding frequency modulation in which the optical frequency increases or decreases approximately linearly over the particular time interval. For example, a light source 110 that emits light with a linear frequency change of 200 MHz over a 2-μs time interval may be referred to as having a frequency modulation m of 10¹⁴ Hz/s (or, 100 MHz/μs).

In addition to producing frequency-modulated emitted light, a light source 110 may also produce frequency-modulated local-oscillator (LO) light. The LO light may be coherent with the emitted light, and the frequency modulation of the LO light may match that of the emitted light. The LO light may be produced by splitting off a portion of the emitted light prior to the emitted light exiting the lidar system. Alternatively, the LO light may be produced by a seed laser diode or a direct-emitter laser diode that is part of the light source 110. For example, the LO light may be emitted from the back facet of a seed laser diode or a direct-emitter laser diode, or the LO light may be split off from the seed light emitted from the front facet of a seed laser diode. The received light (e.g., emitted light that is scattered by a target 130) and the LO light may each be frequency modulated, with a frequency difference or offset that corresponds to the distance to the target 130. For a linearly chirped light source (e.g., a frequency modulation that produces a linear change in frequency with time), the larger the frequency difference is between the received light and the LO light, the farther away the target 130 is located.

A frequency difference between received light and LO light may be determined by mixing the received light with the LO light (e.g., by coupling the two beams onto a detector so they are coherently mixed together at the detector) and determining the resulting beat frequency. For example, a photocurrent signal produced by an APD may include a beat signal resulting from the coherent mixing of the received light and the LO light, and a frequency of the beat signal may correspond to the frequency difference between the received light and the LO light. The photocurrent signal from an APD (or a voltage signal that corresponds to the photocurrent signal) may be analyzed using a frequency-analysis technique (e.g., a fast Fourier transform (FFT) technique) to determine the frequency of the beat signal. If a linear frequency modulation m (e.g., in units of Hz/s) is applied to a CW laser, then the round-trip time T may be related to the frequency difference Δf between the received scattered light and the LO light by the expression T=Δf/m. Additionally, the distance D from the target 130 to the lidar system 100 may be expressed as D=(Δf/m)·c/2, where c is the speed of light. For example, for a light source 110 with a linear frequency modulation of 10¹⁴ Hz/s, if a frequency difference (between the received scattered light and the LO light) of 33 MHz is measured, then this corresponds to a round-trip time of approximately 330 ns and a distance to the target of approximately 50 meters. As another example, a frequency difference of 133 MHz corresponds to a round-trip time of approximately 1.33 μs and a distance to the target of approximately 200 meters. A receiver or processor of an FMCW lidar system may determine a frequency difference between received scattered light and LO light, and the distance to a target may be determined based on the frequency difference. The frequency difference Δf between received scattered light and LO light corresponds to the round-trip time T (e.g., through the relationship T=Δf/m), and determining the frequency difference may correspond to or may be referred to as determining the round-trip time.

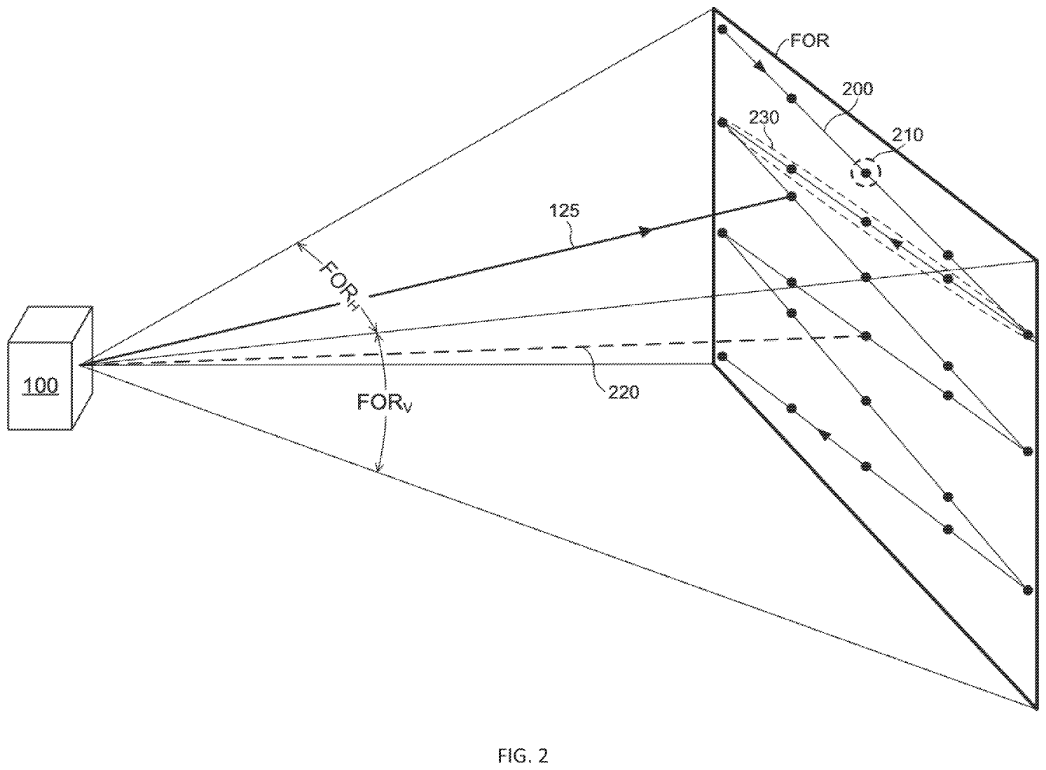

FIG. 2 illustrates an example scan pattern 200 produced by a lidar system 100. A scanner 120 of the lidar system 100 may scan the output beam 125 (which may include multiple emitted optical signals) along a scan pattern 200 that is contained within a FOR of the lidar system 100. A scan pattern 200 (which may be referred to as an optical scan pattern, optical scan path, scan path, or scan) may represent a path or course followed by output beam 125 as it is scanned across all or part of a FOR. Each traversal of a scan pattern 200 may correspond to the capture of a single frame or a single point cloud. In particular embodiments, a lidar system 100 may be configured to scan output optical beam 125 along one or more particular scan patterns 200. In particular embodiments, a scan pattern 200 may scan across any suitable field of regard (FOR) having any suitable horizontal FOR (FOR_{H}) and any suitable vertical FOR (FOR_{V}). For example, a scan pattern 200 may have a field of regard represented by angular dimensions (e.g., FOR_{H}λFOR_{V}) 40°×30°, 90°×40°, or 60°×15°. As another example, a scan pattern 200 may have a FOR_{H} greater than or equal to 10°, 25°, 30°, 40°, 60°, 90°, or 120°. As another example, a scan pattern 200 may have a FOR_{V} greater than or equal to 2°, 5°, 10°, 15°, 20°, 30°, or 45°.

In the example of FIG. 2, reference line 220 represents a center of the field of regard of scan pattern 200. In particular embodiments, reference line 220 may have any suitable orientation, such as for example, a horizontal angle of 0° (e.g., reference line 220 may be oriented straight ahead) and a vertical angle of 0° (e.g., reference line 220 may have an inclination of 0°), or reference line 220 may have a nonzero horizontal angle or a nonzero inclination (e.g., a vertical angle of +10° or)—10°. In FIG. 2, if the scan pattern 200 has a 60°×15° field of regard, then scan pattern 200 covers a ±30° horizontal range with respect to reference line 220 and a ±7.5° vertical range with respect to reference line 220. Additionally, optical beam 125 in FIG. 2 has an orientation of approximately −15° horizontal and +3° vertical with respect to reference line 220. Optical beam 125 may be referred to as having an azimuth of −15° and an altitude of +3° relative to reference line 220. In particular embodiments, an azimuth (which may be referred to as an azimuth angle) may represent a horizontal angle with respect to reference line 220, and an altitude (which may be referred to as an altitude angle, elevation, or elevation angle) may represent a vertical angle with respect to reference line 220.

In particular embodiments, a scan pattern 200 may include multiple pixels 210, and each pixel 210 may be associated with one or more laser pulses or one or more distance measurements. Additionally, a scan pattern 200 may include multiple scan lines 230, where each scan line represents one scan across at least part of a field of regard, and each scan line 230 may include multiple pixels 210. In FIG. 2, scan line 230 includes five pixels 210 and corresponds to an approximately horizontal scan across the FOR from right to left, as viewed from the lidar system 100. In particular embodiments, a cycle of scan pattern 200 may include a total of Pₓ×P_{y} pixels 210 (e.g., a two-dimensional distribution of Pₓ by P_{y} pixels). As an example, scan pattern 200 may include a distribution with dimensions of approximately 100-2,000 pixels 210 along a horizontal direction and approximately 4-400 pixels 210 along a vertical direction. As another example, scan pattern 200 may include a distribution of 1,000 pixels 210 along the horizontal direction by 64 pixels 210 along the vertical direction (e.g., the frame size is 1000×64 pixels) for a total of 64,000 pixels per cycle of scan pattern 200. In particular embodiments, the number of pixels 210 along a horizontal direction may be referred to as a horizontal resolution of scan pattern 200, and the number of pixels 210 along a vertical direction may be referred to as a vertical resolution. As an example, scan pattern 200 may have a horizontal resolution of greater than or equal to 100 pixels 210 and a vertical resolution of greater than or equal to 4 pixels 210. As another example, scan pattern 200 may have a horizontal resolution of 100-2,000 pixels 210 and a vertical resolution of 4-400 pixels 210.

In particular embodiments, a pixel 210 may refer to a data element that includes (i) distance information (e.g., a distance from a lidar system 100 to a target 130 from which an associated pulse of light was scattered) or (ii) an elevation angle and an azimuth angle associated with the pixel (e.g., the elevation and azimuth angles along which the associated pulse of light was emitted). Each pixel 210 may be associated with a distance (e.g., a distance to a portion of a target 130 from which an associated laser pulse was scattered) or one or more angular values. As an example, a pixel 210 may be associated with a distance value and two angular values (e.g., an azimuth and altitude) that represent the angular location of the pixel 210 with respect to the lidar system 100. A distance to a portion of target 130 may be determined based at least in part on a time-of-flight measurement for a corresponding pulse. An angular value (e.g., an azimuth or altitude) may correspond to an angle (e.g., relative to reference line 220) of output beam 125 (e.g., when a corresponding pulse is emitted from lidar system 100) or an angle of input beam 135 (e.g., when an input signal is received by lidar system 100). In particular embodiments, an angular value may be determined based at least in part on a position of a component of scanner 120. As an example, an azimuth or altitude value associated with a pixel 210 may be determined from an angular position of one or more corresponding scanning mirrors of scanner 120.

FIG. 3 illustrates an example lidar system 100 with an example rotating polygon mirror 301. In particular embodiments, a scanner 120 may include a polygon mirror 301 configured to scan output beam 125 along a particular direction. In the example of FIG. 3, scanner 120 includes two scanning mirrors: (1) a polygon mirror 301 that rotates along the Θₓ direction and (2) a scanning mirror 302 that oscillates back and forth along the Θ_{y} direction. The output beam 125 from light source 110, which passes alongside mirror 115, is reflected by reflecting surface 321 of scan mirror 302, is then reflected by a reflecting surface (e.g., surface 320A, 320B, 320C, or 320D) of polygon mirror 301, and then passes through sensor window 157. Scattered light from a target 130 returns to the lidar system 100 as input beam 135. The input beam 135 passes through sensor window 157 and then reflects from polygon mirror 301, scan mirror 302, and mirror 115, which directs input beam 135 through focusing lens 330 and to the detector 340 of receiver 140. As shown in FIG. 3, scan mirror 302 includes reflecting surface 321 and mirror 115 includes reflecting surface 322. The detector 340 may be a PN photodiode, a PIN photodiode, an APD, an SPAD, or any other suitable detector. A reflecting surface 320 (which may be referred to as a reflective surface) may include a reflective metallic coating (e.g., gold, silver, or aluminum) or a reflective dielectric coating, and the reflecting surface 320 may have any suitable reflectivity R at an operating wavelength of the light source 110 (e.g., R greater than or equal to 70%, 80%, 90%, 95%, 98%, or 99%). In the event sensor window 157 contains a blocking contaminant (not shown), portions of output beam 125 may not reach target 130 but are instead scattered or reflected by the blocking contaminant. Some of the scattered or reflected light from the blockage may return toward the lidar system 100 along a similar path to input beam 135. For example, at least a portion of the light scattered or reflected by the blocking contaminant passes through at least a portion of sensor window 157 and then reflects from polygon mirror 301, scan mirror 302, and mirror 115, which directs the returning beam through focusing lens 330 and to the detector 340 of receiver 140.

In particular embodiments, a polygon mirror 301 may be configured to rotate along a Θₓ or Θ_{y} direction and scan output beam 125 along a substantially horizontal or vertical direction, respectively. A rotation along a Ox direction may refer to a rotational motion of mirror 301 that results in output beam 125 scanning along a substantially horizontal direction. Similarly, a rotation along a Θ_{y} direction may refer to a rotational motion that results in output beam 125 scanning along a substantially vertical direction. In FIG. 3, mirror 301 is a polygon mirror that rotates along the Ox direction and scans output beam 125 along a substantially horizontal direction, and mirror 302 pivots along the Θ_{y} direction and scans output beam 125 along a substantially vertical direction. In particular embodiments, a polygon mirror 301 may be configured to scan output beam 125 along any suitable direction. As an example, a polygon mirror 301 may scan output beam 125 at any suitable angle with respect to a horizontal or vertical direction, such as for example, at an angle of approximately 0°, 10°, 20°, 30°, 45°, 60°, 70°, 80°, or 90° with respect to a horizontal or vertical direction.

In particular embodiments, a polygon mirror 301 may refer to a multi-sided object having reflective surfaces 320 on two or more of its sides or faces. As an example, a polygon mirror may include any suitable number of reflective faces (e.g., 2, 3, 4, 5, 6, 7, 8, or 10 faces), where each face includes a reflective surface 320. A polygon mirror 301 may have a cross-sectional shape of any suitable polygon, such as for example, a triangle (with three reflecting surfaces 320), square (with four reflecting surfaces 320), pentagon (with five reflecting surfaces 320), hexagon (with six reflecting surfaces 320), heptagon (with seven reflecting surfaces 320), or octagon (with eight reflecting surfaces 320). In FIG. 3, the polygon mirror 301 has a substantially square cross-sectional shape and four reflecting surfaces (320A, 320B, 320C, and 320D). The polygon mirror 301 in FIG. 3 may be referred to as a square mirror, a cube mirror, or a four-sided polygon mirror. In FIG. 3, the polygon mirror 301 may have a shape similar to a cube, cuboid, or rectangular prism. Additionally, the polygon mirror 301 may have a total of six sides, where four of the sides include faces with reflective surfaces (320A, 320B, 320C, and 320D).

In particular embodiments, a polygon mirror 301 may be continuously rotated in a clockwise or counter-clockwise rotation direction about a rotation axis of the polygon mirror 301. The rotation axis may correspond to a line that is perpendicular to the plane of rotation of the polygon mirror 301 and that passes through the center of mass of the polygon mirror 301. In FIG. 3, the polygon mirror 301 rotates in the plane of the drawing, and the rotation axis of the polygon mirror 301 is perpendicular to the plane of the drawing. An electric motor may be configured to rotate a polygon mirror 301 at a substantially fixed frequency (e.g., a rotational frequency of approximately 1 Hz (or 1 revolution per second), 10 Hz, 50 Hz, 100 Hz, 500 Hz, or 1,000 Hz). As an example, a polygon mirror 301 may be mechanically coupled to an electric motor (e.g., a synchronous electric motor) which is configured to spin the polygon mirror 301 at a rotational speed of approximately 160 Hz (or, 9600 revolutions per minute (RPM)).

In particular embodiments, output beam 125 may be reflected sequentially from the reflective surfaces 320A, 320B, 320C, and 320D as the polygon mirror 301 is rotated. This results in the output beam 125 being scanned along a particular scan axis (e.g., a horizontal or vertical scan axis) to produce a sequence of scan lines, where each scan line corresponds to a reflection of the output beam 125 from one of the reflective surfaces of the polygon mirror 301. In FIG. 3, the output beam 125 reflects off of reflective surface 320A to produce one scan line. Then, as the polygon mirror 301 rotates, the output beam 125 reflects off of reflective surfaces 320B, 320C, and 320D to produce a second, third, and fourth respective scan line. In particular embodiments, a lidar system 100 may be configured so that the output beam 125 is first reflected from polygon mirror 301 and then from scan mirror 302 (or vice versa). As an example, an output beam 125 from light source 110 may first be directed to polygon mirror 301, where it is reflected by a reflective surface of the polygon mirror 301, and then the output beam 125 may be directed to scan mirror 302, where it is reflected by reflective surface 321 of the scan mirror 302. In the example of FIG. 3, the output beam 125 is reflected from the polygon mirror 301 and the scan mirror 302 in the reverse order. In FIG. 3, the output beam 125 from light source 110 is first directed to the scan mirror 302, where it is reflected by reflective surface 321, and then the output beam 125 is directed to the polygon mirror 301, where it is reflected by reflective surface 320A.

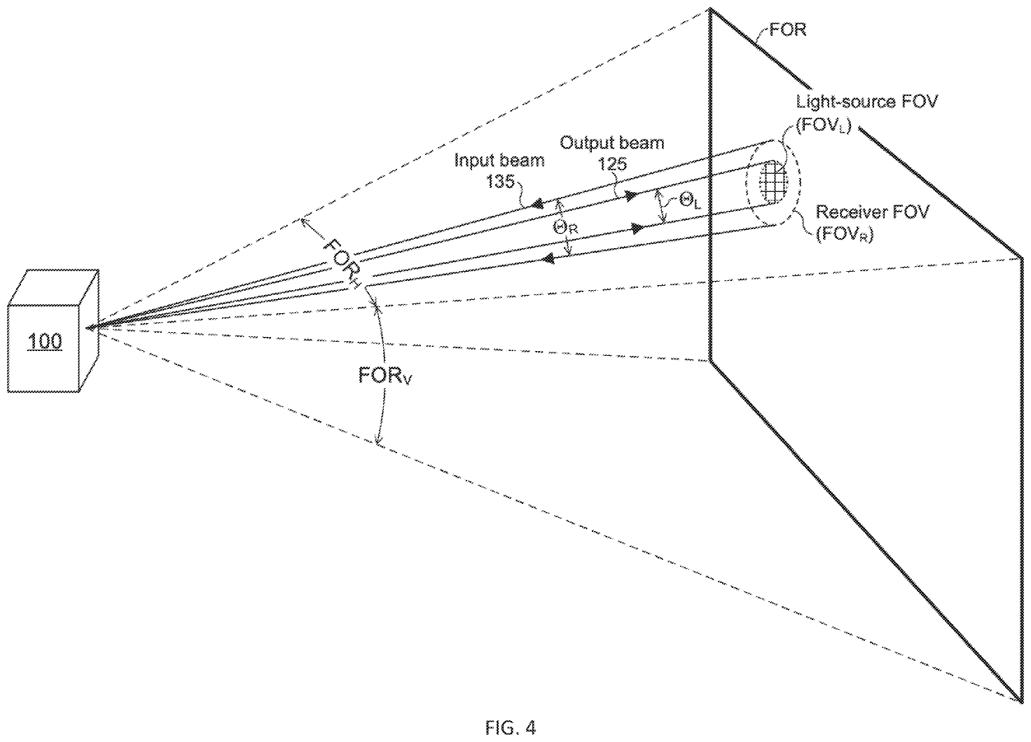

FIG. 4 illustrates an example light-source field of view (FOV_{L}) and receiver field of view (FOV_{R}) for a lidar system 100. A light source 110 of lidar system 100 may emit pulses of light as the FOV_{L} and FOV_{R} are scanned by scanner 120 across a field of regard (FOR). In particular embodiments, a light-source field of view may refer to an angular cone illuminated by the light source 110 at a particular instant of time. Similarly, a receiver field of view may refer to an angular cone over which the receiver 140 may receive or detect light at a particular instant of time, and any light outside the receiver field of view may not be received or detected. As an example, as the light-source field of view is scanned across a field of regard, a portion of a pulse of light emitted by the light source 110 may be sent downrange from lidar system 100, and the pulse of light may be sent in the direction that the FOV_{L} is pointing at the time the pulse is emitted. The pulse of light may scatter off a target 130, and the receiver 140 may receive and detect a portion of the scattered light that is directed along or contained within the FOV_{R}.

In particular embodiments, scanner 120 may be configured to scan both a light-source field of view and a receiver field of view across a field of regard of the lidar system 100. Multiple pulses of light may be emitted and detected as the scanner 120 scans the FOV_{L} and FOV_{R} across the field of regard of the lidar system 100 while tracing out a scan pattern 200. In particular embodiments, the light-source field of view and the receiver field of view may be scanned synchronously with respect to one another, so that as the FOV_{L} is scanned across a scan pattern 200, the FOV_{R} follows substantially the same path at the same scanning speed. Additionally, the FOV_{L} and FOV_{R} may maintain the same relative position to one another as they are scanned across the field of regard. As an example, the FOV_{L} may be substantially overlapped with or centered inside the FOV_{R} (as illustrated in FIG. 4), and this relative positioning between FOV_{L} and FOV_{R} may be maintained throughout a scan. As another example, the FOV_{R} may lag behind the FOV_{L} by a particular, fixed amount throughout a scan (e.g., the FOV_{R} may be offset from the FOV_{L} in a direction opposite the scan direction).

In particular embodiments, the FOV_{L} may have an angular size or extent ΘL that is substantially the same as or that corresponds to the divergence of the output beam 125, and the FOV_{R} may have an angular size or extent ΘR that corresponds to an angle over which the receiver 140 may receive and detect light. In particular embodiments, the receiver field of view may be any suitable size relative to the light-source field of view. As an example, the receiver field of view may be smaller than, substantially the same size as, or larger than the angular extent of the light-source field of view. In particular embodiments, the light-source field of view may have an angular extent of less than or equal to 50 milliradians, and the receiver field of view may have an angular extent of less than or equal to 50 milliradians. The FOV_{L} may have any suitable angular extent ΘL, such as for example, approximately 0.1 mrad, 0.2 mrad, 0.5 mrad, 1 mrad, 1.5 mrad, 2 mrad, 3 mrad, 5 mrad, 10 mrad, 20 mrad, 40 mrad, or 50 mrad. Similarly, the FOV_{R} may have any suitable angular extent ΘR, such as for example, approximately 0.1 mrad, 0.2 mrad, 0.5 mrad, 1 mrad, 1.5 mrad, 2 mrad, 3 mrad, 5 mrad, 10 mrad, 20 mrad, 40 mrad, or 50 mrad. In particular embodiments, the light-source field of view and the receiver field of view may have approximately equal angular extents. As an example, Θ_{L} and Θ_{R} may both be approximately equal to 1 mrad, 2 mrad, or 4 mrad. In particular embodiments, the receiver field of view may be larger than the light-source field of view, or the light-source field of view may be larger than the receiver field of view. As an example, Θ_{L} may be approximately equal to 3 mrad, and Θ_{R} may be approximately equal to 4 mrad. As another example, Θ_{R} may be approximately L times larger than Θ_{L}, where L is any suitable factor, such as for example, 1.1, 1.2, 1.5, 2, 3, 5, or 10.

In particular embodiments, a pixel 210 may represent or may correspond to a light-source field of view or a receiver field of view. As the output beam 125 propagates from the light source 110, the diameter of the output beam 125 (as well as the size of the corresponding pixel 210) may increase according to the beam divergence Θ_{L}. As an example, if the output beam 125 has a Θ_{L} of 2 mrad, then at a distance of 100 m from the lidar system 100, the output beam 125 may have a size or diameter of approximately 20 cm, and a corresponding pixel 210 may also have a corresponding size or diameter of approximately 20 cm. At a distance of 200 m from the lidar system 100, the output beam 125 and the corresponding pixel 210 may each have a diameter of approximately 40 cm.

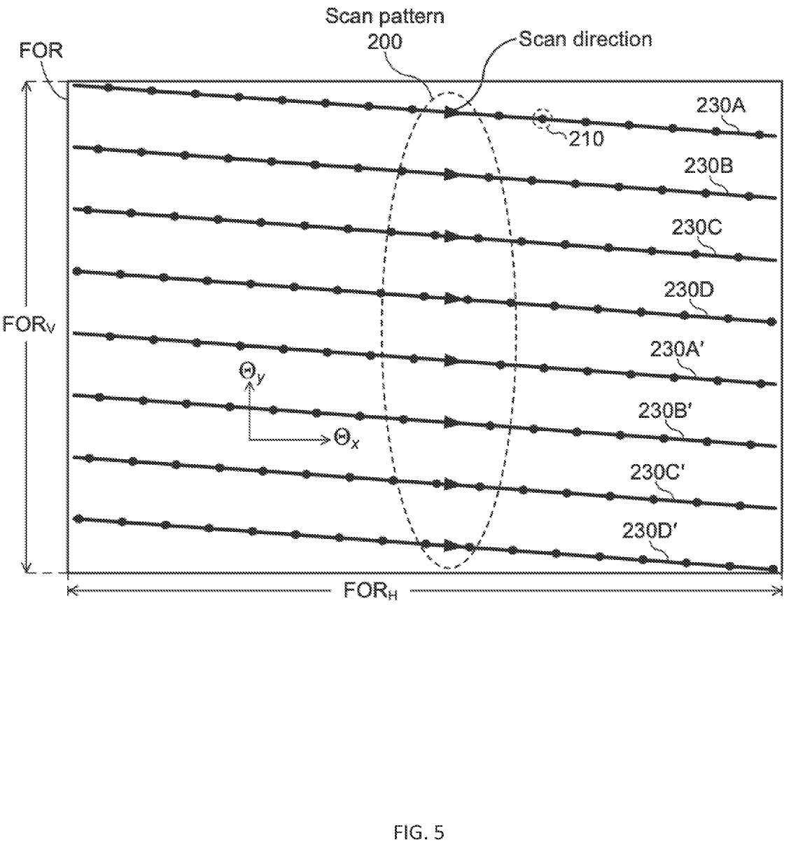

FIG. 5 illustrates an example unidirectional scan pattern 200 that includes multiple pixels 210 and multiple scan lines 230. In particular embodiments, scan pattern 200 may include any suitable number of scan lines 230 (e.g., approximately 1, 2, 5, 10, 20, 50, 100, 500, or 1,000 scan lines), and each scan line 230 of a scan pattern 200 may include any suitable number of pixels 210 (e.g., 1, 2, 5, 10, 20, 50, 100, 200, 500, 1,000, 2,000, or 5,000 pixels). The scan pattern 200 illustrated in FIG. 5 includes eight scan lines 230, and each scan line 230 includes approximately 16 pixels 210. In particular embodiments, a scan pattern 200 where the scan lines 230 are scanned in two directions (e.g., alternately scanning from right to left and then from left to right) may be referred to as a bidirectional scan pattern 200, and a scan pattern 200 where the scan lines 230 are scanned in the same direction may be referred to as a unidirectional scan pattern 200. The scan pattern 200 in FIG. 2 may be referred to as a bidirectional scan pattern, and the scan pattern 200 in FIG. 5 may be referred to as a unidirectional scan pattern 200 where each scan line 230 travels across the FOR in substantially the same direction (e.g., approximately from left to right as viewed from the lidar system 100). In particular embodiments, scan lines 230 of a unidirectional scan pattern 200 may be directed across a FOR in any suitable direction, such as for example, from left to right, from right to left, from top to bottom, from bottom to top, or at any suitable angle (e.g., at a 0°, 5°, 10°, 30°, or 45° angle) with respect to a horizontal or vertical axis. In particular embodiments, each scan line 230 in a unidirectional scan pattern 200 may be a separate line that is not directly connected to a previous or subsequent scan line 230.

In particular embodiments, a unidirectional scan pattern 200 may be produced by a scanner 120 that includes a polygon mirror (e.g., polygon mirror 301 of FIG. 3), where each scan line 230 is associated with a particular reflective surface 320 of the polygon mirror. As an example, reflective surface 320A of polygon mirror 301 in FIG. 3 may produce scan line 230A in FIG. 5. Similarly, as the polygon mirror 301 rotates, reflective surfaces 320B, 320C, and 320D may successively produce scan lines 230B, 230C, and 230D, respectively. Additionally, for a subsequent revolution of the polygon mirror 301, the scan lines 230A′, 230B′, 230C′, and 230D′ may be successively produced by reflections of the output beam 125 from reflective surfaces 320A, 320B, 320C, and 320D, respectively. In particular embodiments, N successive scan lines 230 of a unidirectional scan pattern 200 may correspond to one full revolution of an N-sided polygon mirror. As an example, the four scan lines 230A, 230B, 230C, and 230D in FIG. 5 may correspond to one full revolution of the four-sided polygon mirror 301 in FIG. 3. Additionally, a subsequent revolution of the polygon mirror 301 may produce the next four scan lines 230A′, 230B′, 230C′, and 230D′ in FIG. 5.

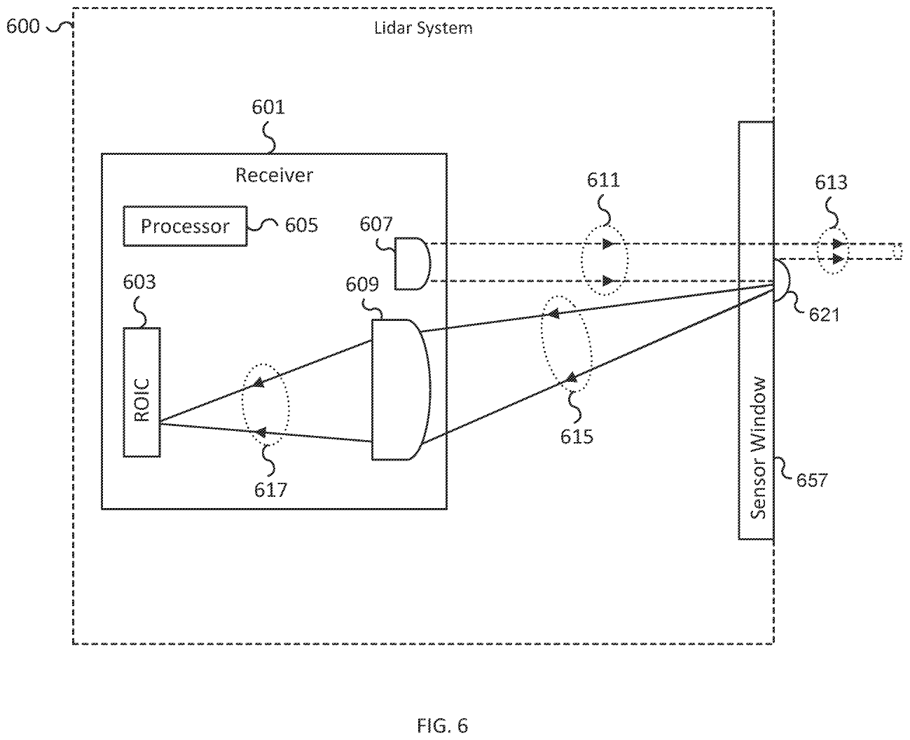

FIG. 6 illustrates an embodiment of a lidar system capable of detecting blocking contaminants. In the example shown, lidar system 600 includes at least receiver 601 and sensor window 657. In some embodiments, lidar system 600 is lidar system 100 of FIG. 1. In order to focus on the functionality of receiver 601, additional components of lidar system 600, such as a light source, mirrors, a scanner, and a controller are not shown. In the example of FIG. 6, receiver 601 includes readout integrated circuit (ROIC) 603, processor 605, transmit lens 607, and receive lens 609. Transmit lens 607 focuses output beam 611 in order to scan a field of regard. As shown in the example, blocking contaminant 621 resides on sensor window 657 of lidar system 600 and at least partially blocks output beam 611, splitting output beam 611 into scattered light and partial output beam 613. At least a portion of the scattered light is represented as input beam 615 and focused input beam 617. In various embodiments, receiver 601 is receiver 140 of FIG. 1 and sensor window 657 is sensor window 157 of FIG. 1. In some embodiments, output beam 611 and partial output beam 613 are associated with output beam 125 of FIG. 1, and input beam 615 and focused input beam 617 correspond to input beam 135 of FIG. 1.

In some embodiments, lidar system 600 emits output beam 611 that is collimated by transmit lens 607. Output beam 611 at least partially passes through sensor window 657. In various embodiments, sensor window 657 is a window used to protect the internal components of lidar system 600. For example, sensor window 657 can act as a shield to protect the internal components of lidar system 600 from environmental elements such as road debris and weather while still allowing lidar system 600 to emit output beam 611 and to detect light scattered by downrange objects. In various embodiments, at sensor window 657, output beam 611 is at least partially split by blocking contaminant 621. Partial output beam 613 is the portion of output beam 611 that is not blocked by blocking contaminant 621 and can reach a downrange object (not shown). For simplicity, FIG. 6 does not show the corresponding input beam detected by lidar system 600 and used by receiver 601 to detect a downrange object when partial output beam 613 reaches the downrange object. As shown in the example, lidar system 600 can detect blocking contaminants that are smaller than the beam size of output beam 611. Moreover, in the event a blocking contaminant is smaller than the beam size of output beam 611, lidar system 600 can still detect downrange objects. For example, partial output beam 613 is able to bypass blocking contaminant 621 to reach a downrange object.

In various embodiments, blocking contaminant 621 can be dust, a liquid, or another blockage that adheres to the exterior surface of sensor window 657. In some embodiments, blocking contaminant 621 is embedded within blocking contaminant 621. For example, blocking contaminant 621 can be a chip or a pit that degrades the ability for sensor window 657 to pass output beam 611 uninterrupted or with minimal degradation. As shown in FIG. 6, blocking contaminant 621 scatters at least a portion of output beam 611. A portion of the scattered light passes (at least partially) back through sensor window 657 as input beam 615 towards receiver 601. At receiver 601, input beam 615 is focused by receive lens 609 to direct focused input beam 617 at readout integrated circuit (ROIC) 603. In some embodiments, the fronts of transmit lens 607 and receive lens 609 are aligned and the distance from the front of transmit lens 607 and the front of receive lens 609 to the front of sensor window 657 is the same.

In various embodiments, ROIC 603 contains one or more detectors (not shown) for detecting scattered light including scattered light from downrange objects (not shown) as well as scattered light from blocking contaminant 621. At ROIC 603, one or more blocking contaminant detectors (not shown) detect focused input beam 617. In the event focused input beam 617 is detected at ROIC 603, ROIC 603 outputs a corresponding sensor reading. The sensor reading can be an electronic signal corresponding to a measurement of the detected scattered light of focused input beam 617. In some embodiments, processor 605 is communicatively connected to ROIC 603 and analyzes the output of ROIC 603. In some embodiments, processor 605 outputs a determination of whether a blocking contaminant is detected on sensor window 657.

In some embodiments, the distance between corresponding reference points (not shown) of transmit lens 607 and receive lens 609 is the parallax measurement of lidar system 600. For example, in some embodiments, there is a minimum parallax distance between the transmit and receive axes of transmit lens 607 and receive lens 609. In some embodiments, the parallax distance between the transmit axis of a transmit lens, such as transmit lens 607, and the receive axis of a receive lens, such as receive lens 609, exceeds 4 millimeters. Moreover, lidar system 600 can be configured wherein the transmit lens and the receive lens are not coaxial. In some embodiments, the distance from the front of transmit lens 607 (and/or the front of receive lens 609) to the front of sensor window 657 is an optical path length of lidar system 600. The optical path length from one or more lenses, such as transmit lens 607 and/or receive lens 609, to sensor window 657 is at least a minimum optical path length distance and does not exceed a maximum optical path length distance. In some embodiments, the shortest optical path length between a transmit lens, such as transmit lens 607, and the sensor window, such as sensor window 657, is between 20 and 300 millimeters. In some embodiments, the optical path length is a short distance, for example, relative to the distance of downrange objects. In various embodiments, the different measurements can be used to configure the position of the different lenses, the distance of the sensor window from the lenses, the properties of the lenses, and the position of ROIC 603 and its associated detectors. The accurate positioning of the various components of lidar system 600, including the location of detector sites of ROIC 603, is critical in order to accurately detect both downrange objects and blocking contaminants.

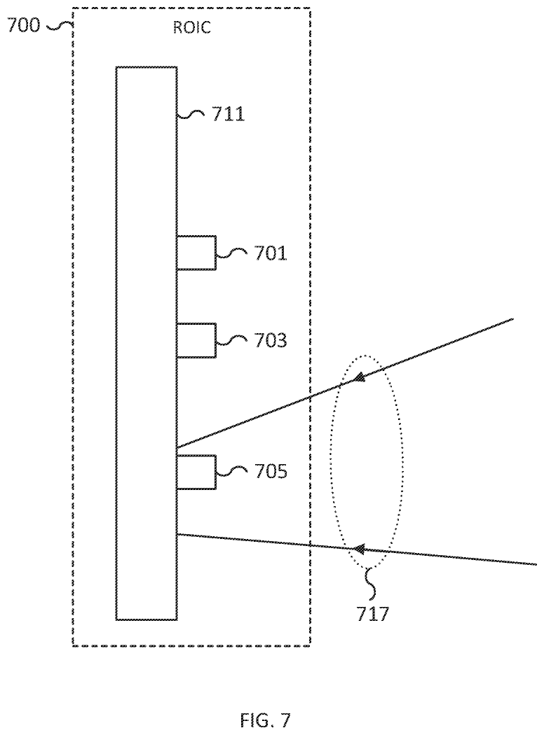

FIG. 7 illustrates an embodiment of a readout integrated circuit (ROIC) component of a lidar system capable of detecting blocking contaminants. In the example shown, readout integrated circuit (ROIC) 700 of a lidar system includes at least the main body component 711 of ROIC 700 and detector site locations 701, 703, and 705. Detector site location 705 is located within the beam pattern of focused input beam 717, which corresponds to at least a portion of the light scattered from a blocking contaminant of the sensor window of the lidar system. In the example shown, detector site locations 701 and 703 are primary detector site locations for detecting downrange objects and detector site location 705 is a blocking contaminant detector site location for detecting blocking contaminants of the sensor window of the lidar system. In some embodiments, the lidar system of FIG. 7 is lidar system 100 of FIG. 1 and/or lidar system 600 of FIG. 6, ROIC 700 is ROIC 603 of FIG. 6, and/or focused input beam 717 is focused input beam 617 of FIG. 6. In some embodiments, focused input beam 717 corresponds to light scattered from blocking contaminant 621 of FIG. 6 that is associated with sensor window 657 of FIG. 6.

In some embodiments, detector site locations 701, 703, and 705 are positioned to each detect different scatter patterns. In the example shown, ROIC 700 includes two primary detector site locations, detector site locations 701 and 703. In some embodiments, one, two, or more primary detector site locations are utilized to detect different scatter patterns and the different scatter patterns can correspond to one, two, or more different output beams. For example, two primary detector site locations can be utilized by the lidar system to detect scatter patterns associated with two different output beams and their corresponding input beams. In some embodiments, multiple different output beams can be split from a single original beam. In various embodiments, detector site location 705 is a blocking contaminant detector site location and a blocking contaminant detector is specifically located at detector site location 705 to detect scatter patterns associated with a blocking contaminant on the sensor window. As shown in FIG. 7, detector site location 705 is located within the beam pattern of focused input beam 717 and allows ROIC 700 to detect the existence of a blocking contaminant on the sensor window.

In some embodiments, main body component 711 of ROIC 700 is the main component of a readout integrated circuit. In some embodiments, ROIC 700 is an application-specific integrated circuit (ASIC) with light detectors. For example, main body component 711 can be an ASIC designed for reading/processing signals from light detectors positioned at detector site locations 701, 703, and 705. The actual light detectors can be coupled and/or mounted directly to the ASIC and may have an output that is electrically connected to the input of the ASIC. In various embodiments, ROIC 700, including main body component 711, captures sensor data from associated light detectors and can output corresponding output signals such as readout values that can be used to analyze the captured sensor data results. In some embodiments, ROIC 700 outputs a signal that can be analyzed by a processor such as processor 605 of FIG. 6. In some embodiments, ROIC 700 performs functionality such as current-to-voltage conversion, voltage amplification, filtering, edge/level detection, timing, time-to-digital conversion, and/or blockage detection such as one or more steps of a process for detecting and reporting blocking contaminants impacting the sensor window.

In the example shown, ROIC 700 includes only a single blocking contaminant detector site location (i.e., detector site location 705). In some embodiments, ROIC 700 can include multiple blocking contaminant detector site locations (not shown) such as different blocking contaminant detector site locations to capture different scatter patterns from different output beams and their corresponding input beams. For example, the location of each blocking contaminant detector site location can be optimized to detect scatter patterns associated with one or more different input beams. As another example, in some embodiments, a lidar system utilizes two different output beams with two different primary detector site locations for detecting downrange objects and two different blocking contaminant detector site locations to differentiate the scatter patterns of blocking contaminants that are generated by the two different output beams.

In some embodiments, a single blocking contaminant detector site location is utilized for multiple output beams. For example, scatter patterns associated with two different output beams can be detected at a single blocking contaminant detector site location. In the event only a single blocking contaminant detector site location is utilized for multiple output beams, the single blocking contaminant detector site location is located where the scatter patterns of the different output beams overlap. In contrast, when multiple blocking contaminant detector site locations are utilized, the different blocking contaminant detector site locations can be positioned outside of where the scatter patterns of the different output beams overlap. Each blocking contaminant detector site location is configured to only detect scatter patterns associated with their associated output beam(s).

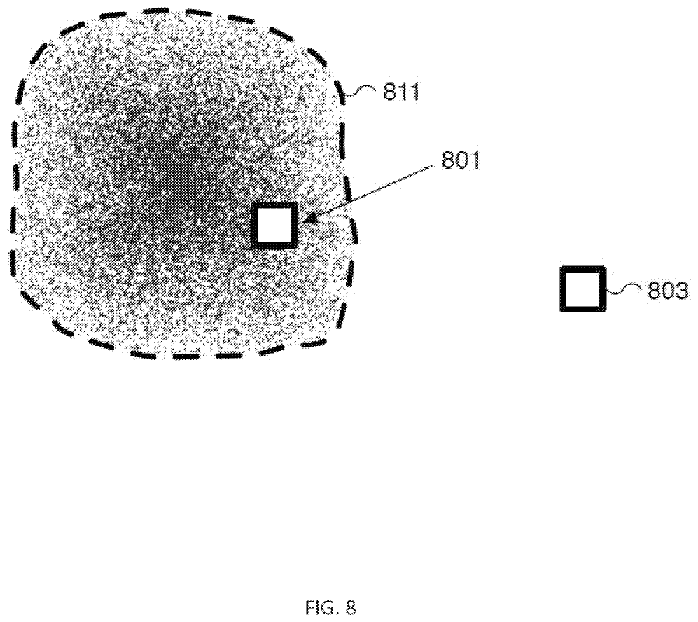

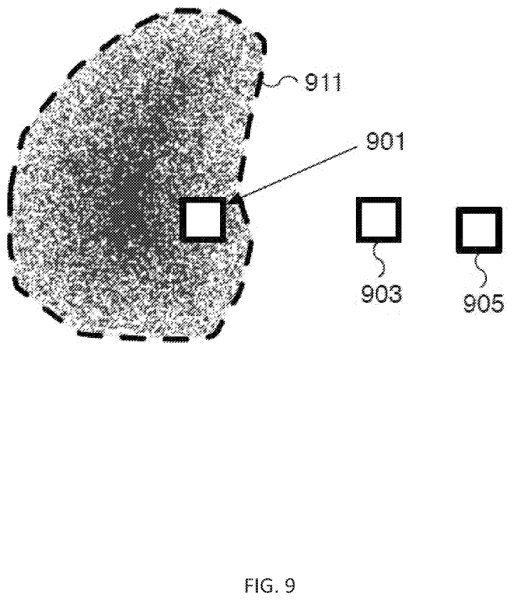

FIG. 8 illustrates an example scatter pattern relative to detector site locations of a readout integrated circuit (ROIC) component of a lidar system capable of detecting blocking contaminants. In the example shown, scatter pattern 811 corresponds to an input beam captured from the light scattered by a blocking contaminant on a sensor window of the lidar system. The dots within the dashed outline of scatter pattern 811 can correspond to a pattern found on a detector plane of a ROIC in response to at least a portion of the captured light from the light scattered by a blocking contaminant on a sensor window. In the example of FIG. 8, the ROIC includes two detector site locations 801 and 803. Detector site location 801 is a blocking contaminant detector site location for detecting blocking contaminants on the sensor window and is located inside of scatter pattern 811. Detector site location 803 is a primary detector site location for detecting downrange objects and is located outside of scatter pattern 811. In contrast to ROIC 700 of FIG. 7, the ROIC of FIG. 8 is an embodiment that includes only two detector locations with only a single primary detector location and a single blocking contaminant detector location. Alternative embodiments with multiple primary detector locations, such as the ROICs of FIGS. 9-12, are appropriate as well. In some embodiments, the lidar system associated with the ROIC of FIG. 8 is lidar system 100 of FIG. 1 and/or lidar system 600 of FIG. 6 and the receiver associated with the ROIC of FIG. 8 is receiver 140 of FIG. 1 and/or receiver 601 of FIG. 6. In some embodiments, scatter pattern 811 corresponds to the scatter pattern generated by input beam 135 of FIG. 1 and/or focused input beam 617 of FIG. 6.

In some embodiments, scatter pattern 811 is an example scatter pattern associated with an output beam hitting a blocking contaminant on a sensor window of the lidar system. For example, the output beam is reflected and/or scattered by the blocking contaminant and at least a portion of the scattered and/or reflected output beam is captured by the lidar sensor as an input beam. In some embodiments, the input beam is focused by a receive lens, such as receive lens 609 of FIG. 6, before being directed to the ROIC of the receiver. For example, in various embodiments, scatter pattern 811 corresponds to the focused input beam that is directed to the ROIC of FIG. 8. The location of detector site location 801 is positioned to detect various scatter patterns, such as scatter pattern 811, that correspond to an output beam hitting a blocking contaminant on a sensor window. In various embodiments, detector site location 801 is located in an area bounded by the outline of scatter pattern 811. Similarly, the location of detector site location 803 is positioned outside of the various scatter patterns, such as scatter pattern 811, that correspond to an output beam hitting a blocking contaminant on a sensor window. In various embodiments, due to the positioning of the detector site locations, a scatter pattern that corresponds to the output beam hitting a downrange object is only captured by detector site location 803 and not detector site location 801. In this manner, detector site location 801 is a blocking contaminant detector site location for detecting blocking contaminants and detector site location 803 is a primary detector site location for detecting downrange objects.

FIG. 9 illustrates an example scatter pattern relative to detector site locations of a readout integrated circuit (ROIC) component of a lidar system capable of detecting blocking contaminants. In the example shown, scatter pattern 911 corresponds to an input beam captured from the light scattered by a blocking contaminant on a sensor window of the lidar system. The dots within the dashed outline of scatter pattern 911 can correspond to a pattern found on a detector plane of a ROIC in response to at least a portion of the captured light from the light scattered by a blocking contaminant on a sensor window. In the example of FIG. 9, the ROIC includes three detector site locations 901, 903, and 905. Detector site location 901 is a blocking contaminant detector site location for detecting blocking contaminants on the sensor window and is located inside of scatter pattern 911. Detector site locations 903 and 905 are primary detector site locations for detecting downrange objects from different output beams and are both located outside of scatter pattern 911. In contrast to the ROIC of FIG. 8, the ROIC of FIG. 9 is an embodiment that includes three detector locations with two primary detector locations (i.e., detector site locations 903 and 905) and a single blocking contaminant detector site location (i.e., detector site location 901). In some embodiments, the ROIC of FIG. 9 is ROIC 700 of FIG. 7 and detector site locations 901, 903, and 905 are detector site locations 705, 703, and 701 of FIG. 7, respectively. In some embodiments, the lidar system associated with the ROIC of FIG. 9 is lidar system 100 of FIG. 1 and/or lidar system 600 of FIG. 6 and the receiver associated with the ROIC of FIG. 9 is receiver 140 of FIG. 1 and/or receiver 601 of FIG. 6. In some embodiments, scatter pattern 911 corresponds to the scatter pattern generated by input beam 135 of FIG. 1 and/or focused input beam 617 of FIG. 6.

In some embodiments, scatter pattern 911 is an example scatter pattern associated with one of multiple output beams emitted by a lidar system hitting a blocking contaminant on a sensor window of the lidar system. For example, the lidar system can emit two different output beams via a shared sensor window to scan different fields of regard. Scatter from downrange objects for each emitted output beam can be detected by the different primary detector locations 903 and 905. In some embodiments, the scatter associated with a downrange object of a first output beam can be detected by detector site location 903 and the scatter associated with a downrange object of a second output beam can be detected by detector site location 905. When an output beam hits a blocking contaminant, instead of primarily reaching a downrange object, at least a portion of the output beam is reflected and/or scattered by the blocking contaminant and at least a portion of the scattered and/or reflected output beam is captured by the lidar sensor as an input beam. For example, an output beam is reflected and/or scattered by the blocking contaminant and at least a portion of the scattered and/or reflected output beam is captured by the lidar sensor as an input beam. In some embodiments, the input beam is focused by a receive lens, such as receive lens 609 of FIG. 6, before being directed to the ROIC of the receiver. For example, in various embodiments, scatter pattern 911 corresponds to a focused input beam that is directed to the ROIC of FIG. 9.

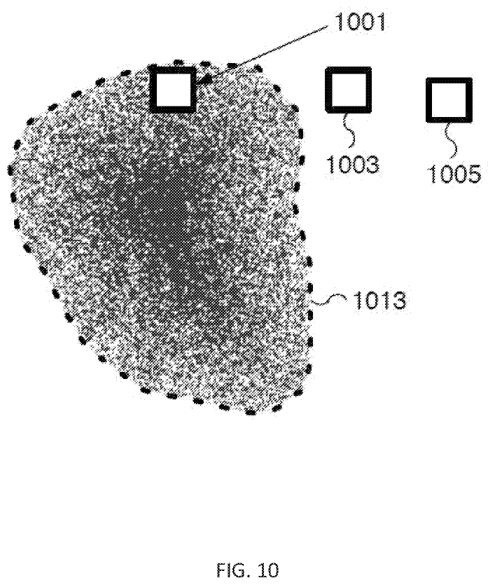

In various embodiments, due to the scanning configuration of the different output beams, the corresponding scatter patterns associated with the different emitted output beams hitting a blocking contaminant on the sensor window present themselves differently on the detector plane of the ROIC. Scatter pattern 911 is an example of a scatter pattern from a first emitted output beam that corresponds to downrange objects detected at detector site location 901. Although an example scatter pattern of the second emitted output beam is now shown in FIG. 9 (see FIG. 10 for an example scatter pattern of the second emitted output beam), detector site location 901 is positioned to detect not only the scatter pattern of blocking contaminants of the first emitted output beam but also the scatter pattern of blocking contaminants of the second emitted output beam. For example, detector site location 901 is located in an area bounded by the outline of the scatter pattern of blocking contaminants of the first emitted output beam and also in an area bounded by the outline of the scatter pattern of blocking contaminants of the second emitted output beam. In some embodiments, the scatter pattern of blocking contaminants of a particular output beam is the intersection of all possible scatter patterns for that beam. Detector site location 901 is able to detect scatter patterns of blocking contaminants associated with both output beams by being positioned in a location where the scatter patterns corresponding to the different output beams overlap.

In some embodiments, when detector site location 901 detects scatter associated with a blocking contaminant on the sensor window, additional processing is performed by the receiver and/or processor of the lidar system in order to differentiate between a scatter pattern associated with the first and second emitted output beams. Although additional processing may be required to differentiate which emitted output beam is the source of the scatter pattern, by positioning detector site location 901 in a location where the scatter patterns of the different emitted output beams overlap, only a single detector site location (i.e., detector site location 901) is required to detect a blocking contaminant even when a lidar system utilizes multiple output beams.

In various embodiments, the locations of the two primary detector locations (i.e., detector site locations 903 and 905) are positioned outside of the various blocking contaminant scatter patterns, such as scatter pattern 911. For example, detector site locations 903 and 905 cannot detect scatter pattern 911. In some embodiments, due to the positioning of the detector site locations, a scatter pattern that corresponds to one of the output beams hitting a downrange object is only captured by primary detector site locations 903 and/or 905 and not blocking contaminant detector site location 901. In this manner, detector site location 901 is a blocking contaminant detector site location for detecting blocking contaminants and detector site locations 903 and 905 are primary detector site locations for detecting downrange objects.

FIG. 10 illustrates an example scatter pattern relative to detector site locations of a readout integrated circuit (ROIC) component of a lidar system capable of detecting blocking contaminants. In the example shown, scatter pattern 1013 corresponds to an input beam captured from the light scattered by a blocking contaminant on a sensor window of the lidar system. The dots within the dashed outline of scatter pattern 1013 can correspond to a pattern found on a detector plane of a ROIC in response to at least a portion of the captured light from the light scattered by a blocking contaminant on a sensor window. In the example of FIG. 10, the ROIC includes three detector site locations 1001, 1003, and 1005. Detector site location 1001 is a blocking contaminant detector site location for detecting blocking contaminants on the sensor window and is located inside of scatter pattern 1013. Detector site locations 1003 and 1005 are primary detector site locations for detecting downrange objects from different output beams and are both located outside of scatter pattern 1013. In various embodiments, the ROIC of FIG. 10 is the ROIC of FIG. 9 and detector site locations 1001, 1003, and 1005 correspond to detector site locations 901, 903, and 905 of FIG. 9, respectively. In some embodiments, the ROIC of FIG. 10 is ROIC 700 of FIG. 7 and detector site locations 1001, 1003, and 1005 are detector site locations 705, 703, and 701 of FIG. 7, respectively. In some embodiments, the lidar system associated with the ROIC of FIG. 10 is lidar system 100 of FIG. 1 and/or lidar system 600 of FIG. 6 and the receiver associated with the ROIC of FIG. 10 is receiver 140 of FIG. 1 and/or receiver 601 of FIG. 6. In some embodiments, scatter pattern 1013 corresponds to the scatter pattern generated by input beam 135 of FIG. 1 and/or focused input beam 617 of FIG. 6.

In some embodiments, scatter pattern 1013 is an example scatter pattern associated with an output beam emitted by a lidar system hitting a blocking contaminant on a sensor window of the lidar system. For example, the lidar system can emit two different output beams via a shared sensor window to scan different fields of regard. Scatter from downrange objects for each emitted output beam can be detected by the different primary detector locations 1003 and 1005. In some embodiments, the scatter associated with a downrange object of a first output beam can be detected by detector site location 1003 and the scatter associated with a downrange object of a second output beam can be detected by detector site location 1005. When an output beam hits a blocking contaminant, instead of primarily reaching a downrange object, at least a portion of the output beam is reflected and/or scattered by the blocking contaminant and at least a portion of the scattered and/or reflected output beam is captured by the lidar sensor as an input beam. For example, an output beam is reflected and/or scattered by the blocking contaminant and at least a portion of the scattered and/or reflected output beam is captured by the lidar sensor as an input beam. In some embodiments, the input beam is focused by a receive lens, such as receive lens 609 of FIG. 6, before being directed to the ROIC of the receiver. For example, in various embodiments, scatter pattern 1013 corresponds to a focused input beam that is directed to the ROIC of FIG. 10.

In various embodiments, due to the scanning configuration of the different output beams, the corresponding scatter patterns associated with the different emitted output beams hitting a blocking contaminant on the sensor window present themselves differently on the detector plane of the ROIC. For example, whereas scatter pattern 911 of FIG. 9 is an example of a scatter pattern from a first emitted output beam that corresponds to downrange objects detected at detector site location 903 of FIG. 9 and/or detector site location 1003, scatter pattern 1013 is an example of a scatter pattern from a second emitted output beam that corresponds to downrange objects detected at detector site location 905 of FIG. 9 and/or detector site location 1005. By locating detector site location 1001 where the different scatter patterns 911 of FIGS. 9 and 1013 overlap, detector site location 1001 is able to detect scatter patterns of blocking contaminants associated with both output beams. For example, as with detector site location 901 of FIG. 9, detector site location 1001 is positioned to detect not only the scatter pattern of blocking contaminants of the first emitted output beam but also the scatter pattern of blocking contaminants of the second emitted output beam. In various embodiments, detector site location 1001 is located in an area bounded by the outline of the scatter pattern of blocking contaminants of the first emitted output beam and also in an area bounded by the outline of the scatter pattern of blocking contaminants of the second emitted output beam. In some embodiments, the scatter pattern of blocking contaminants of a particular output beam is the intersection of all possible scatter patterns for that beam.

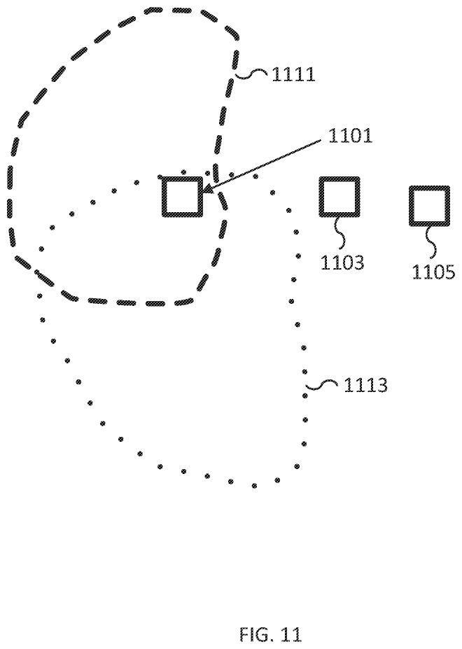

FIG. 11 illustrates example scatter patterns relative to detector site locations of a readout integrated circuit (ROIC) component of a lidar system with a single blocking contaminant detector site location. In the example shown, scatter patterns 1111 and 1113 correspond to two different input beams captured from two different emitted output beams hitting blocking contaminants on a sensor window of the lidar system. Unlike the scatter patterns of FIGS. 8-10, only the outline of each scatter pattern is shown for clarity. The dashed outlines of scatter patterns 1111 and 1113 correspond to different patterns found on a detector plane of a ROIC in response to at least a portion of the captured light from emitted output beams scattered by blocking contaminants on a sensor window. In the example of FIG. 11, the ROIC includes three detector site locations 1101, 1103, and 1105. Detector site location 1101 is a blocking contaminant detector site location for detecting blocking contaminants on the sensor window and detector site locations 1103 and 1105 are primary detector site locations for detecting downrange objects from different output beams. In various embodiments, the ROIC of FIG. 11 is the ROIC of FIGS. 9 and 10 and detector site locations 1101, 1103, and 1105 are detector site locations 901, 903, and 905 of FIG. 9, respectively, and also detector site locations 1001, 1003, and 1005 of FIG. 10, respectively. Similarly, scatter pattern 1111 is scatter pattern 911 of FIG. 9 and scatter pattern 1113 is scatter pattern 1013 of FIG. 10.

In various embodiments, due to the scanning configuration of the different output beams, the corresponding scatter patterns associated with the different emitted output beams hitting a blocking contaminant on the sensor window present themselves differently on the detector plane of the ROIC. For example, scatter pattern 1111 is an example of a scatter pattern from a first emitted output beam that corresponds to downrange objects detected at detector site location 1103 and scatter pattern 1113 is an example of a scatter pattern from a second emitted output beam that corresponds to downrange objects detected at detector site location 1105. As shown in the example of FIG. 11, detector site location 1101 is located where scatter patterns 1111 and 1113 overlap. By locating detector site location 1101 where the different scatter patterns 1111 and 1113 overlap, detector site location 1101 is able to detect scatter patterns of blocking contaminants associated with both output beams. For example, as with detector site location 901 of FIG. 9 and detector site location 1001 of FIG. 10, detector site location 1101 is positioned to detect not only the scatter pattern of blocking contaminants of the first emitted output beam but also the scatter pattern of blocking contaminants of the second emitted output beam. As shown in FIG. 11, detector site location 1101 is located in the area bounded by the outline of scatter pattern 1111 and also in the area bounded by the outline of scatter pattern 1113. Although additional processing may be required to differentiate which emitted output beam is the source of a scatter pattern detected by detector site location 1101, by positioning detector site location 1101 in a location where the scatter patterns of the different emitted output beams overlap, only a single detector site location (i.e., detector site location 1101) is required to detect a blocking contaminant even when a lidar system utilizes multiple output beams.

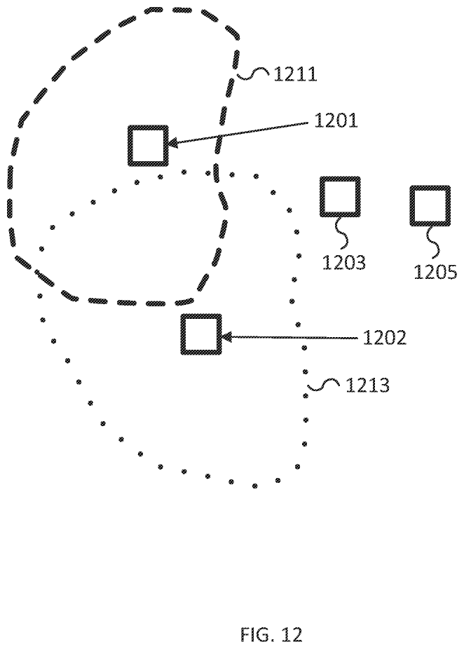

FIG. 12 illustrates example scatter patterns relative to detector site locations of a readout integrated circuit (ROIC) component of a lidar system with multiple blocking contaminant detector site locations. In the example shown, scatter patterns 1211 and 1213 correspond to two different input beams captured from two different emitted output beams hitting blocking contaminants on a sensor window of the lidar system. Unlike the scatter patterns of FIGS. 8-10, only the outline of each scatter pattern is shown for clarity. The dashed outlines of scatter patterns 1211 and 1213 each correspond to different patterns found on a detector plane of a ROIC in response to at least a portion of the captured light from emitted output beams scattered by blocking contaminants on a sensor window. In the example of FIG. 12, the ROIC includes four detector site locations 1201, 1202, 1203, and 1205. Detector site locations 1201 and 1202 are blocking contaminant detector site locations for detecting blocking contaminants on the sensor window and detector site locations 1203 and 1205 are primary detector site locations for detecting downrange objects from different emitted output beams. Unlike the ROICs of FIGS. 7-11, the ROIC of FIG. 12 includes two blocking contaminant detector site locations, detector site locations 1201 and 1202. Detector site locations 1201 and 1202 are used to differentiate between scatter patterns caused by the different output beams and are each associated with a different emitted output beam. In some embodiments, the lidar system associated with the ROIC of FIG. 12 is lidar system 100 of FIG. 1 and/or lidar system 600 of FIG. 6 and the receiver associated with the ROIC of FIG. 12 is receiver 140 of FIG. 1 and/or receiver 601 of FIG. 6. In some embodiments, scatter patterns 1211 and 1213 correspond to scatter patterns generated by input beam 135 of FIG. 1 and/or focused input beam 617 of FIG. 6.

In the example of FIG. 12, primary detector site locations 1203 and 1205 correspond to detector site locations 903 and 905 of FIG. 9, detector site locations 1003 and 1005 of FIG. 10, and detector site locations 1103 and 1105 of FIG. 11. Similarly, scatter pattern 1211 corresponds to scatter patterns 911 of FIGS. 9 and 1111 of FIG. 11, and scatter pattern 1213 corresponds to scatter patterns 1013 of FIGS. 10 and 1113 of FIG. 11. However, unlike the ROICs of FIGS. 9-11, the ROIC of FIG. 12 includes two blocking contaminant detector site locations, detector site location 1201 and 1202. Instead of locating a single blocking contaminant detector site location, such as detector site location 901 of FIG. 9, detector site location 1001 of FIG. 10, and/or detector site location 1101 of FIG. 11, within the overlap of the scatter patterns of the different emitted output beams, each blocking contaminant detector site location of FIG. 12 is positioned in a location where only the scatter patterns associated with a single emitted output beam are found on the detector plane of the ROIC. For example, detector site location 1201 is located only within scatter pattern 1211 and detector site location 1202 is located only within scatter pattern 1213. Neither detector site location 1201 nor detector site location 1202 are located where scatter patterns 1211 and 1213 overlap. In various embodiments, detector site location 1201 is located in the area bounded by the outline of scatter pattern 1211 and outside of the area bounded by the outline of scatter pattern 1213. Similarly, detector site location 1202 is located outside of the area bounded by the outline of scatter pattern 1211 and inside of the area bounded by the outline of scatter pattern 1213. By positioning each blocking contaminant detector site location in a location where only the corresponding scatter patterns of a particular emitted output beam are found on the detector plane of the ROIC, the lidar system can more quickly differentiate between detected scatter patterns. For example, when a detector at a blocking contaminant detector site location detects a scatter pattern associated with a blocking contaminant, identifying which blocking contaminant detector site location detects the scatter pattern allows the system to determine which corresponding emitted output beam was interrupted by a blocking contaminant on the sensor window. In various embodiments, utilizing multiple blocking contaminant detector site locations allows the lidar system to operate at a higher refresh rate.

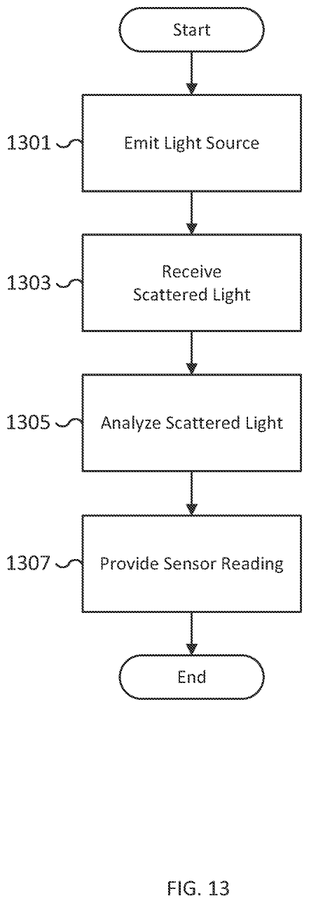

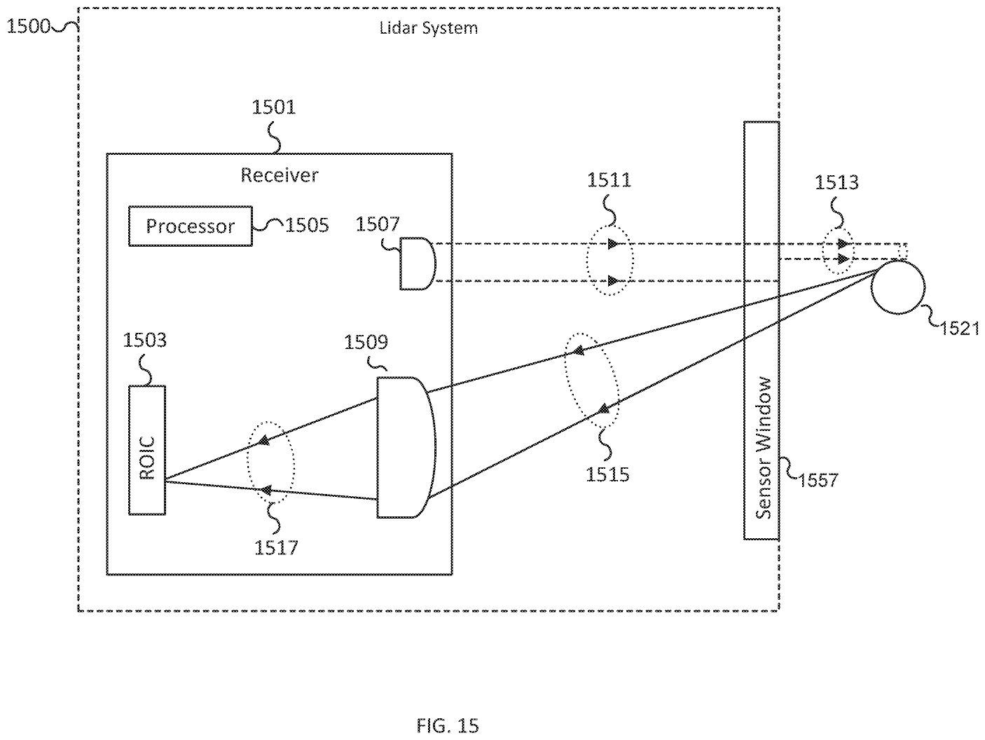

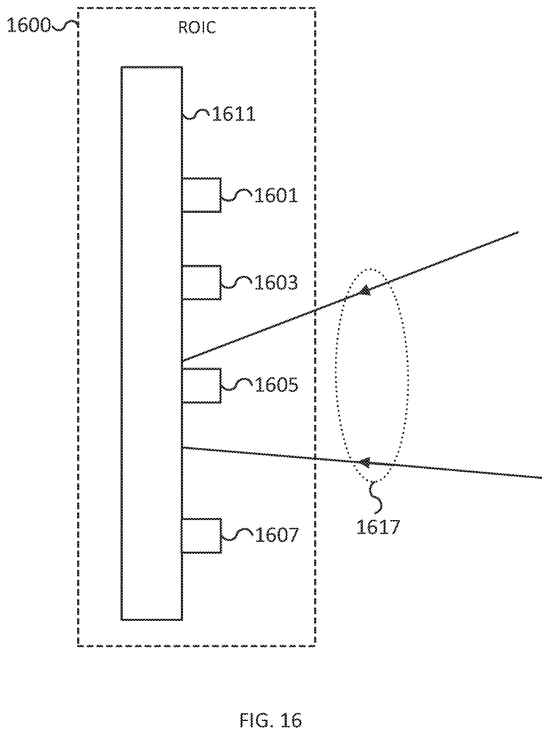

FIG. 13 is a flow chart illustrating an embodiment of a process of a lidar system for detecting objects. Using the process of FIG. 13, a lidar system can detect objects including downrange objects as well as blocking contaminants on a sensor window of the lidar system and blocking close objects in front of the sensor window. For example, a vehicle equipped with the disclosed lidar system can detect other vehicles, pedestrians, lane markers, and street signs, etc. that are downrange from the vehicle as well as debris, pitting, chips and/or other blocking contaminants on the sensor window and/or a human head or other objects close to the sensor window. Depending on the orientation and number of lidar systems installed on the vehicle, different fields of regard can be scanned to determine the corresponding environment surrounding the vehicle. Vehicle safety features as well as autonomous driving features can be implemented using the captured environmental data. In various embodiments, using the process of FIG. 13 with the disclosed lidar system, a single process can be performed for detecting downrange objects as well as blocking contaminants on a sensor window of the lidar system and blocking close objects in front of the sensor window. For example, the lidar system can be configured with a sensor window to protect the internal components of the lidar system and from which emitted output beams pass through to reach downrange objects. When the emitted beam hits an object, at least a portion of the scattered and/or reflected light can be captured by the lidar system as an input beam. In some scenarios, the sensor window can be impacted by one or more blocking contaminants, such as debris or other environmental hazards such as dust, mud, liquid, tar, etc. These blocking contaminants can impact the ability of the lidar system to accurately detect downrange objects by blocking the emitted output beam. As part of the process of FIG. 13, both downrange objects and blocking contaminants can be detected. In the event a blocking contaminant is detected, the sensor window can be cleaned and/or inspected, and the sensor readings from the lidar system can be adjusted to account for the detected blockage. In some scenarios, a close object can block the sensor window (e.g., a human walking across a vehicle stopped in front of a stop sign or stop light). In the event a blocking close object is detected, the intensity of emitted output beams can be reduced in order to avoid potentially causing harm (e.g., to an eye of a human). In some embodiments, the lidar system performing the process of FIG. 13 is lidar system 100 of FIG. 1, lidar system 600 of FIG. 6, and/or lidar system 1500 of FIG. 15. In some embodiments, the ROIC of the lidar system is ROIC 603 of FIG. 6, ROIC 700 of FIG. 7, ROIC 1503 of FIG. 15, ROIC 1600 of FIG. 16, and/or one or more of the ROICS of FIGS. 8-12 and FIG. 16.

At 1301, one or more light sources are emitted. For example, an output light beam is emitted from the lidar system that passes through a sensor window. The sensor window can act as a protective barrier for the lidar system while still allowing light to pass in both directions. In some embodiments, the lidar system emits multiple output beams, each potentially scanning a different field of regard. The output beam can reach downrange objects and can be scattered and/or reflected by the downrange object. In some scenarios, the output beam is at least partially blocked by a blocking contaminant on the sensor window and/or a blocking close object in front of the sensor window. A portion of the output beam may avoid the blocking contaminant and/or close object and can reach downrange from the lidar system while another portion of the output beam is reflected and/or scattered by the blocking contaminant and/or close object.

At 1303, scattered light is received. For example, light scattered and/or reflected by an object is received at the lidar sensor. The corresponding object can be a downrange object as well as a blocking contaminant on the sensor window or a close object in front of the sensor window. In various embodiments, the received scattered light passes through the same sensor window that the originating light source was emitted from at 1301. In some embodiments, the transmit and receive axes of the emitted light and received light are offset, for example, by a parallax distance configured for the lidar system.

At 1305, the received scattered light is analyzed. For example, the received scattered light is directed to a receiver component of the lidar system where sensor data can be captured and analyzed. In some embodiments, the receiver component includes a receive lens for focusing the received scattered light onto a readout integrated circuit (ROIC) of the receiver where detector site locations of the detector plane are located. The detector site locations can be used to detect scatter patterns associated with the received scattered light. In various embodiments, different detector site locations are utilized to detect light scattered from a downrange object compared to light scattered from a blocking contaminant on the sensor window or a blocking close object in front of the sensor window. In some embodiments, different detector site locations are utilized to differentiate light scattered from different emitted output beams. Using detectors positioned at the detector site locations, sensor data can be captured and analyzed for sensor readings. In some embodiments, the analysis is performed at least in part by the readout integrated circuit (ROIC) and/or processor of the receiver and/or a controller of the lidar system. The processing can include determining an output signal corresponding to the detected scatter pattern. In some embodiments, the output signal is a sensor reading that corresponds to a measurement of the detected scattered light, such as an intensity reading or another measured sensor reading. In some embodiments, the output signal indicates whether a blocking contaminant is detected on the sensor window and/or a blocking close object is detected in front of the sensor window. For example, an output signal can identify a blocking contaminant on the sensor window and may include a location or approximate location on the window where the blocking contaminant is located.

At 1307, a sensor reading is provided. For example, one or more sensor readings are provided in response to the analysis of the received scattered light performed at 1305. The sensor reading can be an intensity reading and/or another measurement or measurements. In some embodiments, the sensor reading includes location and/or distance data. For example, sensor readings can correspond to a point cloud based on objects detected in the fields of regard scanned by the lidar system. In some embodiments, a sensor reading includes an output signal for identifying that a blocking contaminant on the sensor window and/or a blocking close object in front of the sensor window has been detected. The output signal can include a location such as a specific and/or approximate location on the window where the blocking contaminant is located and/or a specific and/or approximate location in front of the window where the blocking close object is located. In various embodiments, an output signal can correspond to a blocking contaminant notification that can be used to trigger a cleaning and/or inspection process for the sensor window and/or a blocking close object notification that can be used to trigger an output beam power reduction process.

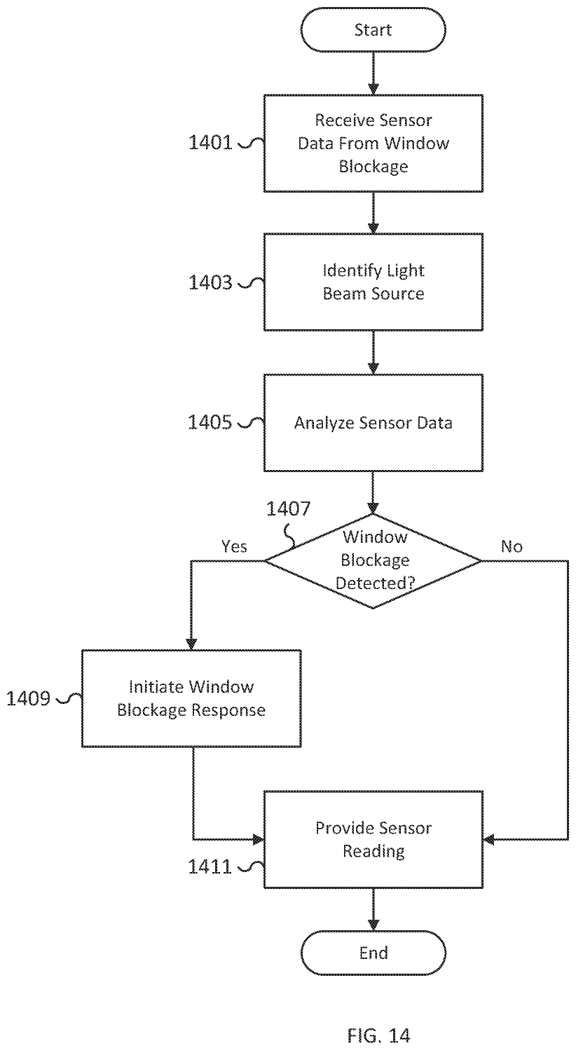

FIG. 14 is a flow chart illustrating an embodiment of a process for detecting blocking contaminants on a sensor window. Using the process of FIG. 14, a lidar system can detect and initiate a response to blocking contaminants on the sensor window of the lidar system. In various embodiments, when an emitted output beam hits a blocking contaminant on the sensor window, at least a portion of the light scattered and/or reflected by the blocking contaminant can be captured by the lidar system as an input beam. By analyzing the light scattered and/or reflected by the blocking contaminant, the lidar system can detect blocking contaminants and initiate a response to the detected blockage. In some embodiments, the lidar system performing the process of FIG. 14 is lidar system 100 of FIG. 1 and/or lidar system 600 of FIG. 6. In some embodiments, the ROIC of the lidar system is ROIC 603 of FIG. 6, ROIC 700 of FIG. 7, and/or one or more of the ROICS of FIGS. 8-12. In some embodiments, the process of FIG. 14 is performed as part of performing the process of FIG. 13. For example, in some embodiments, step 1401 is performed at 1303 of FIG. 13, steps 1403, 1405, and/or 1407 are performed at 1305 of FIG. 13, and/or steps 1409 and/or 1411 are performed at 1307 of FIG. 13.

At 1401, sensor data from a window blockage is received. For example, light scattered and/or reflected by a window contaminant is captured by the lidar system. The light scattered can correspond to an emitted output beam that hits a window contaminant on the sensor window. The scattered and/or reflected light passes back into the lidar system through the same sensor window associated with the emitted output beam. In some embodiments, the receive path is offset from the transmit path based on a parallax distance and the received input beam is directed to a receiver of the lidar system. For example, one or more mirrors and/or lenses can be utilized to direct the input beam to sensor components of a lidar system receiver. In various embodiments, at the receiver component, detectors are positioned to capture and receive sensor data associated with at least a portion of the light scattered by the blocking contaminant.

At 1403, a light source beam is identified. For example, the emitted output light beam that corresponds to the sensor data received at 1401 is identified. In some embodiments, the lidar system includes multiple emitted output beams. For example, a lidar system with multiple output beams can be configured such that each output beam can scan a different field of regard. This allows the multi-output beam lidar system to cover a larger field of regard in the same amount of time or the same field of regard in a shorter amount of time than a lidar system with a single or fewer output beam(s). In various embodiments, the output beam corresponding to the scatter pattern associated with the received sensor data is identified. In some embodiments, a single detector site location is used to detect the scatter patterns of multiple beams and additional analysis is performed at 1403 to differentiate which of the output beams is the source output beam. In some embodiments, the output beam is determined based on the particular detector site location that detects the scatter pattern. For example, different detector site locations can be positioned to detect scatter patterns associated with different output beams.

At 1405, sensor data is analyzed. For example, the sensor data received at 1401 is analyzed. In some embodiments, the analysis is performed at least in part by the readout integrated circuit (ROIC) and/or processor of the receiver and/or a controller of the lidar system. In some embodiments, the analysis is performed as described with respect to step 1305 of FIG. 13. The processing can include determining an output signal corresponding to the detected scatter pattern. For example, the sensor data can be analyzed based at least in part on the light beam source identified at 1403 to determine an output signal such as a sensor reading. The sensor reading can correspond to a measurement of the detected scattered light, such as an intensity reading or another measured sensor reading. In some embodiments, the output signal indicates whether a blocking contaminant is detected on the sensor window. For example, an output signal can identify a blocking contaminant on the sensor window and may include a location or approximate location on the window where the blocking contaminant is located.

At 1407, a determination is made whether a window blockage is detected. For example, the lidar system detects a blocking contaminant on the sensor window. In the event a window blockage is detected, processing proceeds to 1409 where the detected window contaminant can be addressed. In the event no window blockage is detected, processing proceeds to 1411.

At 1409, a window blockage response is initiated. For example, a blocking contaminant on the sensor window is detected and a response is initiated to address the detected blocking contaminant. In some embodiments, the response is a process to clean the blockage from the window. For example, a cleaning process can be initiated to clear debris and/or other contaminants from the sensor window. In some embodiments, the response includes an inspection step, for example, to determine what level and/or type of response is appropriate to address the detected blocking contaminant. For example, in the event the sensor window is chipped, pitted, or otherwise damaged, a sensor window replacement process can be initiated. In some embodiments, the appropriate window blockage response includes modification to the analysis of downrange objects detected by the lidar system. For example, the analysis process for detecting downrange objects and their properties (such as distance) can be adjusted to compensate for portions of an emitted output beam hitting a blocking contaminant on the sensor window.

At 1411, a sensor reading is provided. For example, one or more sensor readings are provided in response to the analysis performed at 1405 on the sensor data received at 1401. The sensor reading can be an intensity reading and/or another measurement or measurements. In some embodiments, a sensor reading includes an output signal for identifying that a blocking contaminant on the sensor window has been detected. The output signal can include a location, such as a specific and/or approximate location, on the window where the blocking contaminant is located. In various embodiments, an output signal can reference the source of the emitted output beam associated with the blocking contaminant. In some embodiments, the sensor reading is an output signal that indicates that no blocking contaminant is found for a particular emitted output beam.

FIG. 15 illustrates an embodiment of a lidar system capable of detecting blocking close objects. In the example shown, lidar system 1500 includes at least receiver 1501 and sensor window 1557. In some embodiments, lidar system 1500 is lidar system 100 of FIG. 1 and/or lidar system 600 of FIG. 6. In order to focus on the functionality of receiver 1501, additional components of lidar system 1500, such as a light source, mirrors, a scanner, and a controller are not shown. In the example of FIG. 15, receiver 1501 includes readout integrated circuit (ROIC) 1503, processor 1505, transmit lens 1507, and receive lens 1509. Transmit lens 1507 collimates output beam 1511 in order to scan a field of regard. As shown in the example, blocking close object 1521 resides in front of sensor window 1557 of lidar system 1500 and at least partially blocks output beam 1511, splitting output beam 1511 into scattered light and partial output beam 1513. It is also possible for blocking close object 1521 to completely block output beam 1511. An example of a blocking close object 1521 is a human head. At least a portion of the scattered light is represented as input beam 1515 and focused input beam 1517. In various embodiments, receiver 1501 is receiver 140 of FIG. 1 and/or receiver 601 of FIG. 6 and sensor window 1557 is sensor window 157 of FIG. 1 and/or sensor window 657 of FIG. 6. In some embodiments, output beam 1511 and partial output beam 1513 are associated with output beam 125 of FIG. 1, and input beam 1515 and focused input beam 1517 correspond to input beam 135 of FIG. 1.

In some embodiments, lidar system 1500 emits output beam 1511 that is collimated by transmit lens 1507. Output beam 1511 at least partially passes through sensor window 1557. In various embodiments, sensor window 1557 is a window used to protect the internal components of lidar system 1500. For example, sensor window 1557 can act as a shield to protect the internal components of lidar system 1500 from environmental elements such as road debris and weather while still allowing lidar system 1500 to emit output beam 1511 and to detect light scattered by downrange objects. In various embodiments, in front of sensor window 1557, output beam 1511 is at least partially split by blocking close object 1521. Partial output beam 1513 is the portion of output beam 1511 that is not blocked by blocking close object 1521 and can reach a downrange object (not shown). For simplicity, FIG. 15 does not show the corresponding input beam detected by lidar system 1500 and used by receiver 1501 to detect a downrange object when partial output beam 1513 reaches the downrange object. In many scenarios, a downrange object cannot be detected because blocking close object 1521 is of a size and distance from sensor window 1557 that output beam 1511 is completely blocked and there is no partial output beam 1513 that can reach downrange objects. For example, blocking close object 1521 (not necessarily drawn to scale in FIG. 15) may be a human head that is within half a meter of sensor window 1557. The human head may belong to a person walking across a stopped autonomous vehicle. In such a scenario, in various embodiments, the intensity of output beam 1511 is reduced in order to avoid causing potential harm to organic tissue of the human head. In many scenarios, a high intensity (high power) for output beam 1511 is unlikely to have any utility because it is likely that blocking close object 1521 is of a size and distance from sensor window 1557 that output beam 1511 is completely blocked from reaching downrange objects.

As shown in FIG. 15, blocking close object 1521 scatters at least a portion of output beam 1511. A portion of the scattered light passes (at least partially) back through sensor window 1557 as input beam 1515 towards receiver 1501. At receiver 1501, input beam 1515 is focused by receive lens 1509 to direct focused input beam 1517 at readout integrated circuit (ROIC) 1503. In some embodiments, the fronts of transmit lens 1507 and receive lens 1509 are aligned and the distance from the front of transmit lens 1507 and the front of receive lens 1509 to the front of sensor window 1557 is the same.

In various embodiments, ROIC 1503 contains one or more detectors (not shown) for detecting scattered light including scattered light from downrange objects (not shown), blocking contaminants (not shown, e.g., blocking contaminant 621 of FIG. 6), as well as scattered light from blocking close object 1521. At ROIC 1503, one or more blocking close object detectors (not shown) detect focused input beam 1517. In the event focused input beam 1517 is detected at ROIC 1503, ROIC 1503 outputs a corresponding sensor reading. The sensor reading can be an electronic signal corresponding to a measurement of the detected scattered light of focused input beam 1517. In some embodiments, processor 1505 is communicatively connected to ROIC 1503 and analyzes the output of ROIC 1503. In some embodiments, processor 1505 outputs a determination of whether a blocking close object is detected in front of sensor window 1557. In various embodiments, different measurements (e.g., downrange objects, close blocking objects, and blocking contaminants on sensor window 1557) can be used to configure the position of the transmit lens 1507 and receive lens 1509, the distance of sensor window 1557 from the lenses, the properties of the lenses, and the position of ROIC 1503 and its associated detectors. The accurate positioning of the various components of lidar system 1500, including the location of detector sites of ROIC 1503, is critical in order to accurately detect both downrange objects and blocking close objects and/or contaminants.

FIG. 16 illustrates an embodiment of a readout integrated circuit (ROIC) component of a lidar system capable of detecting blocking objects. In the example shown, readout integrated circuit (ROIC) 1600 of a lidar system includes at least the main body component 1611 of ROIC 1600 and detector site locations 1601, 1603, 1605, and 1607. Detector site location 1605 is located within the beam pattern of focused input beam 1617, which corresponds to at least a portion of the light scattered from a blocking close object in front of the sensor window of the lidar system. In the example shown, detector site locations 1601 and 1603 are primary detector site locations for detecting downrange objects, detector site location 1605 is a blocking close object detector site location for detecting blocking close objects in front of the sensor window of the lidar system, and detector site location 1607 is a blocking contaminant detector site location for detecting blocking contaminants of the sensor window of the lidar system. In some embodiments, the lidar system of FIG. 1600 is lidar system 100 of FIG. 1, lidar system 600 of FIG. 6, and/or lidar system 1500 of FIG. 15. In some embodiments, ROIC 1600 is ROIC 603 of FIG. 6 and/or ROIC 1503 of FIG. 15. In some embodiments, focused input beam 1617 is focused input beam 1517 of FIG. 15. In some embodiments, focused input beam 1617 corresponds to light scattered from blocking close object 1521 of FIG. 15 that is associated with sensor window 1557 of FIG. 15.

In some embodiments, detector site locations 1601, 1603, 1605, and 1607 are positioned to each detect different scatter patterns. In the example shown, ROIC 1600 includes two primary detector site locations, detector site locations 1601 and 1603. In some embodiments, one, two, or more primary detector site locations are utilized to detect different scatter patterns and the different scatter patterns can correspond to one, two, or more different output beams. For example, two primary detector site locations can be utilized by the lidar system to detect scatter patterns associated with two different output beams and their corresponding input beams. In some embodiments, multiple different output beams can be split from a single original beam. In various embodiments, detector site location 1605 is a blocking close object detector site location and a blocking close object detector is specifically located at detector site location 1605 to detect scatter patterns associated with a blocking close object in front of the sensor window. In some embodiments, detector site location 1607 is a blocking contaminant detector site location and a blocking contaminant detector is specifically located at detector site location 1607 to detect scatter patterns associated with a blocking contaminant on the sensor window. As shown in FIG. 16, detector site location 1605 is located within the beam pattern of focused input beam 1617 and allows ROIC 1600 to detect the existence of a blocking close object in front of the sensor window.

In some embodiments, main body component 1611 of ROIC 1600 is the main component of a readout integrated circuit. In some embodiments, ROIC 1600 is an application-specific integrated circuit (ASIC) with light detectors. For example, main body component 1611 can be an ASIC designed for reading/processing signals from light detectors positioned at detector site locations 1601, 1603, 1605, and 1607. The actual light detectors can be coupled and/or mounted directly to the ASIC and may have an output that is electrically connected to the input of the ASIC. In various embodiments, ROIC 1600, including main body component 1611, captures sensor data from associated light detectors and can output corresponding output signals such as readout values that can be used to analyze the captured sensor data results. In some embodiments, ROIC 1600 outputs a signal that can be analyzed by a processor such as processor 1505 of FIG. 15. In some embodiments, ROIC 1600 performs functionality such as current-to-voltage conversion, voltage amplification, filtering, edge/level detection, timing, time-to-digital conversion, and/or blockage detection such as one or more steps of a process for detecting and reporting blocking close objects (e.g., a human head) near the sensor window.

In the example shown, ROIC 1600 includes a single blocking close object detector site location (i.e., detector site location 1605) and a single blocking contaminant detector site location (i.e., detector site location 1607). In some embodiments, ROIC 1600 includes multiple blocking close object detector site locations (not shown) and/or multiple blocking contaminant detector site locations (not shown) such as different blocking close object and/or contaminant detector site locations to capture different scatter patterns from different output beams and their corresponding input beams. For example, the location of each blocking close object and/or contaminant detector site location can be optimized to detect scatter patterns associated with one or more different input beams.

In some embodiments, a single blocking close object detector site location is utilized for multiple output beams. For example, scatter patterns associated with two different output beams can be detected at a single blocking close object detector site location. In the event only a single blocking close object detector site location is utilized for multiple output beams, the single blocking close object detector site location is located where the scatter patterns of the different output beams overlap. In contrast, when multiple blocking close object detector site locations are utilized, the different blocking close object detector site locations can be positioned outside of where the scatter patterns of the different output beams overlap. Each blocking close object detector site location is configured to only detect scatter patterns associated with their associated output beam(s).

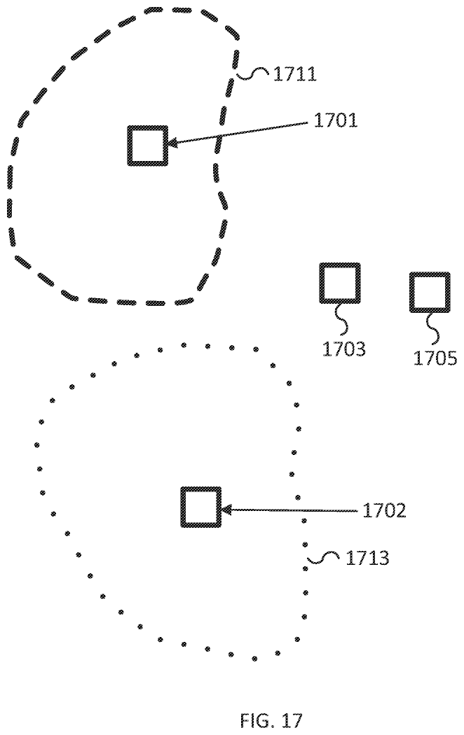

FIG. 17 illustrates example scatter patterns relative to detector site locations of a readout integrated circuit (ROIC) component of a lidar system with blocking close object and contaminant detector site locations. Unlike the scatter patterns of FIGS. 8-10, only the outline of each scatter pattern is shown for clarity. The dashed outlines of scatter patterns 1711 and 1713 each correspond to different patterns found on a detector plane of a ROIC in response to at least a portion of the captured light from one or more emitted output beams scattered by a blocking close object (e.g., a human head) in front of a sensor window and a blocking contaminant (e.g., dirt) on the sensor window, respectively. Thus, in the example of FIG. 17, it is possible to detect a blocking close object and a blocking contaminant simultaneously. In the example of FIG. 17, the ROIC includes four detector site locations 1701, 1702, 1703, and 1705. Detector site locations 1701 and 1702 are blocking close object and blocking contaminant detector site locations, respectively. Detector site locations 1703 and 1705 are primary detector site locations for detecting downrange objects from different emitted output beams. It is also possible for the ROIC to include more detector site locations. For example, in some embodiments, the ROIC includes multiple detector site locations for detecting blocking close objects. Moreover, in some embodiments, the ROIC includes multiple detector site locations for detecting blocking contaminants (e.g., as illustrated in FIG. 12). In some embodiments, the lidar system associated with the ROIC of FIG. 17 is lidar system 100 of FIG. 1, lidar system 600 of FIG. 6, and/or lidar system 1500 of FIG. 15. In some embodiments, the receiver associated with the ROIC of FIG. 17 is receiver 140 of FIG. 1, receiver 601 of FIG. 6, and/or receiver 1501 of FIG. 15. In some embodiments, scatter patterns 1711 and 1713 correspond to scatter patterns generated by input beam 135 of FIG. 1, focused input beam 617 of FIG. 6, and/or focused input beam 1517 of FIG. 15.

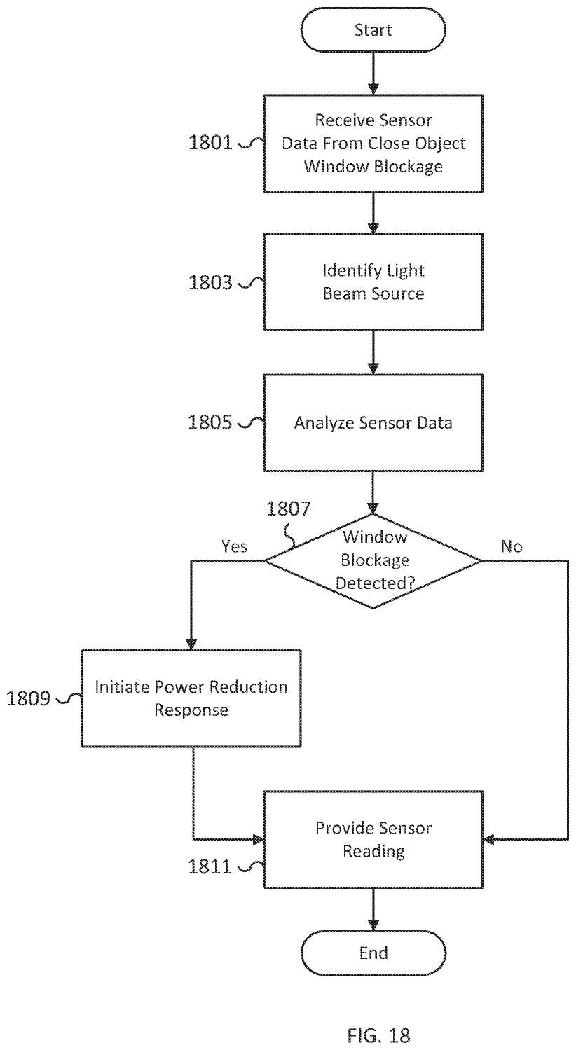

FIG. 18 is a flow chart illustrating an embodiment of a process for detecting blocking close objects in front of a sensor window. Using the process of FIG. 18, a lidar system can detect and initiate a response to blocking close objects in front of the sensor window of the lidar system. In various embodiments, when an emitted output beam hits a blocking close object in front of the sensor window, at least a portion of the light scattered and/or reflected by the blocking close object can be captured by the lidar system as an input beam. By analyzing the light scattered and/or reflected by the blocking close object, the lidar system can detect blocking close objects and initiate a response to the detected blockage. In some embodiments, the lidar system performing the process of FIG. 18 is lidar system 100 of FIG. 1, lidar system 600 of FIG. 6, and/or lidar system 1500 of FIG. 15. In some embodiments, the ROIC of the lidar system is ROIC 603 of FIG. 6, ROIC 700 of FIG. 7, ROIC 1503 of FIG. 15, ROIC 1600 of FIG. 16, and/or one or more of the ROICS of FIGS. 8-12 and FIG. 17. In some embodiments, the process of FIG. 18 is performed as part of performing the process of FIG. 13. For example, in some embodiments, step 1801 is performed at 1303 of FIG. 13, steps 1803, 1805, and/or 1807 are performed at 1305 of FIG. 13, and/or steps 1809 and/or 1811 are performed at 1307 of FIG. 13.

At 1801, sensor data from a close object window blockage is received. For example, light scattered and/or reflected by a close object (e.g., a human head) is captured by the lidar system. The light scattered can correspond to an emitted output beam that hits a close object in front of the sensor window. The scattered and/or reflected light passes back into the lidar system through the same sensor window associated with the emitted output beam. In some embodiments, the receive path is offset from the transmit path based on a parallax distance and the received input beam is directed to a receiver of the lidar system. For example, one or more mirrors and/or lenses can be utilized to direct the input beam to sensor components of a lidar system receiver. In various embodiments, at the receiver component, detectors are positioned to capture and receive sensor data associated with at least a portion of the light scattered by the blocking close object.

At 1803, a light source beam is identified. For example, the emitted output light beam that corresponds to the sensor data received at 1801 is identified. In some embodiments, the lidar system includes multiple emitted output beams. For example, a lidar system with multiple output beams can be configured such that each output beam can scan a different field of regard. This allows the multi-output beam lidar system to cover a larger field of regard in the same amount of time or the same field of regard in a shorter amount of time than a lidar system with a single or fewer output beam(s). In various embodiments, the output beam corresponding to the scatter pattern associated with the received sensor data is identified. In some embodiments, a single detector site location is used to detect the scatter patterns of multiple beams and additional analysis is performed at 1803 to differentiate which of the output beams is the source output beam. In some embodiments, the output beam is determined based on the particular detector site location that detects the scatter pattern. For example, different detector site locations can be positioned to detect scatter patterns associated with different output beams.

At 1805, sensor data is analyzed. For example, the sensor data received at 1801 is analyzed. In some embodiments, the analysis is performed at least in part by the readout integrated circuit (ROIC) and/or processor of the receiver and/or a controller of the lidar system. In some embodiments, the analysis is performed as described with respect to step 1305 of FIG. 13. The processing can include determining an output signal corresponding to the detected scatter pattern. For example, the sensor data can be analyzed based at least in part on the light beam source identified at 1803 to determine an output signal such as a sensor reading. The sensor reading can correspond to a measurement of the detected scattered light, such as an intensity reading or another measured sensor reading. In some embodiments, the output signal indicates whether a blocking object is detected in front of the sensor window. For example, an output signal can identify a blocking close object in front of the sensor window and may include a location or approximate location in front of the window (e.g., including a distance to the window) where the blocking close object is located.

At 1807, a determination is made whether a window blockage is detected. For example, the lidar system detects a blocking close object in front of the sensor window. In the event a window blockage is detected, processing proceeds to 1809 where the detected window blocking close object can be addressed. In the event no window blockage is detected, processing proceeds to 1811.

At 1809, a power reduction response is initiated. For example, a blocking close object in front of the sensor window is detected and a response is initiated to address the detected blockage by reducing output beam power in order to avoid potential harm in case the blockage is at least in part a human being. In some embodiments, the appropriate window blockage response includes modification to the analysis of downrange objects detected by the lidar system. For example, the analysis process for detecting downrange objects and their properties (such as distance) can be adjusted to compensate for reduced power of emitted output beams.

At 1811, a sensor reading is provided. For example, one or more sensor readings are provided in response to the analysis performed at 1805 on the sensor data received at 1801. The sensor reading can be an intensity reading and/or another measurement or measurements. In some embodiments, a sensor reading includes an output signal for identifying that a blocking close object in front of the sensor window has been detected. The output signal can include a location, such as a specific and/or approximate location, in front of the window where the blocking close object is located. In various embodiments, an output signal can reference the source of the emitted output beam associated with the blocking close object. In some embodiments, the sensor reading is an output signal that indicates that no blocking close object is found for a particular emitted output beam.

In particular embodiments, certain features described herein in the context of separate implementations may also be combined and implemented in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variations of a sub-combination.

While operations may be depicted in the drawings as occurring in a particular order, this should not be understood as requiring that such operations be performed in the particular order shown or in sequential order, or that all operations be performed. Further, the drawings may schematically depict one more example processes or methods in the form of a flow diagram or a sequence diagram. However, other operations that are not depicted may be incorporated in the example processes or methods that are schematically illustrated. For example, one or more additional operations may be performed before, after, simultaneously with, or between any of the illustrated operations. Moreover, one or more operations depicted in a diagram may be repeated, where appropriate. Additionally, operations depicted in a diagram may be performed in any suitable order. Furthermore, although particular components, devices, or systems are described herein as carrying out particular operations, any suitable combination of any suitable components, devices, or systems may be used to carry out any suitable operation or combination of operations. In certain circumstances, multitasking or parallel processing operations may be performed. Moreover, the separation of various system components in the implementations described herein should not be understood as requiring such separation in all implementations, and it should be understood that the described program components and systems may be integrated together in a single software product or packaged into multiple software products.

Various embodiments have been described in connection with the accompanying drawings. However, it should be understood that the figures may not necessarily be drawn to scale. As an example, distances or angles depicted in the figures are illustrative and may not necessarily bear an exact relationship to actual dimensions or layouts of the devices illustrated.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes or illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend.

The term “or” as used herein is to be interpreted as an inclusive or meaning any one or any combination, unless expressly indicated otherwise or indicated otherwise by context. Therefore, herein, the expression “A or B” means “A, B, or both A and B.” As another example, herein, “A, B or C” means at least one of the following: A; B; C; A and B; A and C; B and C; A, B and C. An exception to this definition will occur if a combination of elements, devices, steps, or operations is in some way inherently mutually exclusive.

As used herein, words of approximation such as, without limitation, “approximately, “substantially,” or “about” refer to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as having the required characteristics or capabilities of the unmodified feature. In general, but subject to the preceding discussion, a numerical value herein that is modified by a word of approximation such as “approximately” may vary from the stated value by ±0.5%, ±1%, ±2%, ±3%, ±4%, ±5%, ±10%, ±12%, or ±15%. The term “substantially constant” refers to a value that varies by less than a particular amount over any suitable time interval. For example, a value that is substantially constant may vary by less than or equal to 20%, 10%, 1%, 0.5%, or 0.1% over a time interval of approximately 10⁴ s, 10³ s, 10² s, 10 s, 1 s, 100 ms, 10 ms, 1 ms, 100 μs, 10 μs, or 1 μs. The term “substantially constant” may be applied to any suitable value, such as for example, an optical power, a pulse repetition frequency, an electrical current, a wavelength, an optical or electrical frequency, or an optical or electrical phase.

As used herein, the terms “first,” “second,” “third,” etc. may be used as labels for nouns that they precede, and these terms may not necessarily imply a particular ordering (e.g., a particular spatial, temporal, or logical ordering). As an example, a system may be described as determining a “first result” and a “second result,” and the terms “first” and “second” may not necessarily imply that the first result is determined before the second result.

As used herein, the terms “based on” and “based at least in part on” may be used to describe or present one or more factors that affect a determination, and these terms may not exclude additional factors that may affect a determination. A determination may be based solely on those factors which are presented or may be based at least in part on those factors. The phrase “determine A based on B” indicates that B is a factor that affects the determination of A. In some instances, other factors may also contribute to the determination of A. In other instances, A may be determined based solely on B.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a light source configured to emit light;
a scanner configured to scan the emitted light across at least a field of regard through a window;
a first detector configured to detect at least a portion of the emitted light scattered by a target located downrange from the system;
a second detector configured to detect at least a portion of the emitted light scattered by a close object located between the window and a minimum detection distance associated with the first detector; and
a processor configured to analyze detected information from the second detector to provide an indication associated with detecting the close object.

2. The system of claim 1, wherein the first detector, the second detector, a transmit lens, a receive lens, and a readout integrated circuit (ROIC) are included in a receiver component of the system, and wherein the first detector and the second detector are coupled to the readout integrated circuit (ROIC).

3. The system of claim 2, wherein an output beam is included in the emitted light, an input beam is included in the at least the portion of the emitted light scattered by the close object, the output beam passes through the transmit lens, and the input beam passes through the receive lens.

4. The system of claim 3, wherein the output beam and the input beam both pass through at least a same portion of the window.

5. The system of claim 3, wherein a beam size of the output beam is larger than the close object.

6. The system of claim 3, wherein a beam size of the output beam is smaller than or equal in size to the close object.

7. The system of claim 1, wherein the processor is further configured to initiate an output beam power reduction process in response to detecting the at least the portion of the emitted light scattered by the close object.

8. The system of claim 1, wherein the provided indication associated with detecting the close object includes a location of the detected close object.

9. The system of claim 1, wherein the minimum detection distance associated with the first detector is greater than or equal to half a meter.

10. The system of claim 1, wherein the close object includes a human body part.

11. The system of claim 1, further comprising a third detector configured to detect at least a portion of the emitted light scattered by a blocking contaminant on the window.

12. The system of claim 11, wherein the processor is further configured to initiate a cleaning process to at least in part remove the blocking contaminant on the window.

13. The system of claim 11, wherein the processor is further configured to analyze detected information from the third detector to provide an indication associated with detecting the blocking contaminant on the window.

14. The system of claim 13, wherein the provided indication associated with detecting the blocking contaminant on the window includes a location of the detected blocking contaminant on the window.

15. A method, comprising:
emitting light from a light source;
scanning the emitted light across at least a field of regard through a window;
using a first detector to detect at least a portion of the emitted light scattered by a target located downrange;
using a second detector to detect at least a portion of the emitted light scattered by a close object located between the window and a minimum detection distance associated with the first detector; and
analyzing detected information from the second detector to provide an indication associated with detecting the close object.

16. A system, comprising:
a light source configured to emit light;
a scanner configured to scan the emitted light across one or more fields of regard through a window using a first output beam and a second output beam;
a first primary detector configured to detect at least a portion of the emitted light associated with the first output beam scattered by a first target located downrange from the system;
a second primary detector configured to detect at least a portion of the emitted light associated with the second output beam scattered by a second target located downrange from the system;
a close object detector configured to detect at least a portion of the emitted light associated with the first output beam scattered by a close object located between the window and a minimum detection distance associated with the first primary detector; and
a processor configured to analyze detected information from the close object detector to provide an indication associated with detecting the close object.

17. The system of claim 16, further comprising a first blocking contaminant detector configured to detect at least a portion of the emitted light associated with the first output beam scattered by a first blocking contaminant on the window, and wherein the processor is further is configured to analyze detected information from the first blocking contaminant detector to provide an indication associated with detecting the first blocking contaminant on the window.

18. The system of claim 17, wherein the first blocking contaminant detector is further configured to detect at least a portion of the emitted light associated with the second output beam scattered by a second blocking contaminant on the window, and wherein the processor is further configured to analyze detected information from the first blocking contaminant detector to provide an indication associated with detecting the second blocking contaminant on the window.

19. The system of claim 17, further comprising a second blocking contaminant detector configured to detect at least a portion of the emitted light associated with the second output beam scattered by a second blocking contaminant on the window, and wherein the processor is further configured to analyze detected information from the second blocking contaminant detector to provide an indication associated with detecting the second blocking contaminant on the window.

20. The system of claim 17, wherein the first primary detector, the second primary detector, the close object detector, the first blocking contaminant detector, a transmit lens, a receive lens, and a readout integrated circuit (ROIC) are included in a receiver component of the system, and wherein the first primary detector, the second primary detector, the close object detector, and the first blocking contaminant detector are coupled to the readout integrated circuit (ROIC).
